(19) United States
(12) Patent Application Publication
(10) Pub. No.: US 2013/0223307 A1
(43) Pub. Date: Aug. 29, 2013

(54) COMBATING DRX DEADLOCK IN TELECOMMUNICATIONS

(71) Applicants: Anders OHLSSON, Jarfalla (SE); Gunnar Bergquist, Kista (SE); David Better, Stockholm (SE)

(72) Inventors: Anders OHLSSON, Jarfalla (SE); Gunnar Bergquist, Kista (SE); David Better, Stockholm (SE)

(73) Assignee: Telefonaktiebolaget LM Ericsson (publ), Stockholm (SE)

(21) Appl. No.: 13/404,256

(22) Filed: Feb. 24, 2012

(51) Int. Cl. H04W 52/02; H04W 24/10

(52) U.S. Cl. 370/311

(57) ABSTRACT

A method of operating a base station node (28) of a radio access network (22) comprises communicating information over a radio interface (32) between the base station node (28) and a wireless terminal (30) which operates with discontinuous reception (DRX). The base station node (28) determines if the base station node is or may become unsynchronized with a current discontinuous reception (DRX) state of the wireless terminal (30). If so, the base station node (28) resynchronizes operation or takes preventative action to maintain synchronized operation of the base station node (28) with the current discontinuous reception (DRX) state of the wireless terminal (30). The basic method may be practice in either a reactive mode, a proactive mode, or a combined proactive and reactive mode.

### TECHNICAL FIELD

The technology relates to wireless communications, and in particular to discontinuous reception (DRX) functionality.

### BACKGROUND

In a typical cellular radio system, wireless terminals (also known as mobile stations and/or user equipment units (UEs)) communicate via a radio access network (RAN) to one or more core networks. The radio access network (RAN) covers a geographical area which is divided into cell areas, with each cell area being served by a base station, e.g., a radio base station (RBS), which in some networks may also be called, for example, a “NodeB” (UMTS) or “eNodeB” (LTE). A cell is a geographical area where radio coverage is provided by the radio base station equipment at a base station site. Each cell is identified by an identity within the local radio area, which is broadcast in the cell. The base stations communicate over the air interface operating on radio frequencies with the user equipment units (UE) within range of the base stations.

In some versions of the radio access network, several base stations are typically connected (e.g., by landlines or microwave) to a controller node (such as a radio network controller (RNC) or a base station controller (BSC)) which supervises and coordinates various activities of the plural base stations connected thereto. The radio network controllers are typically connected to one or more core networks.

The Universal Mobile Telecommunications System (UMTS) is a third generation mobile communication system, which evolved from the second generation (2G) Global System for Mobile Communications (GSM). UTRAN is essentially a radio access network using wideband code division multiple access for user equipment units (UEs). In a forum known as the Third Generation Partnership Project (3GPP), telecommunications suppliers propose and agree upon standards for third generation networks and UTRAN specifically, and investigate enhanced data rate and radio capacity. Specifications for the Evolved Universal Terrestrial Radio Access Network (E-UTRAN) are ongoing within the 3^{rd} Generation Partnership Project (3GPP). The Evolved Universal Terrestrial Radio Access Network (E-UTRAN) comprises the Long Term Evolution (LTE) and System Architecture Evolution (SAE). Long Term Evolution (LTE) is a variant of a 3GPP radio access technology wherein the radio base station nodes are connected to a core network (via Access Gateways, or AGWs) rather than to radio network controller (RNC) nodes. In general, in LTE the functions of a radio network controller (RNC) node are distributed between the radio base stations nodes (eNodeBs in LTE) and AGWs. As such, the radio access network (RAN) of an LTE system has an essentially “flat” architecture comprising radio base station nodes without reporting to radio network controller (RNC) nodes.

Depending on their quality, transmission channels, and particularly wireless transmission channels, may introduce error in the data being transmitted over the channel. Various techniques have been developed to detect, and even correct, such errors including the errors introduced by the channel. The telecommunications industry has used the Automatic Repeat Request (ARQ) layer 2 protocol for many years to ensure that data is sent reliably from one node to another. More recently, the 3GPP Long Term Evolution (LTE) standard has taken advantage of features such as adaptive coding and modulation (AMC) and a hybrid automatic repeat request (HARQ) process to counteract errors.

Hybrid ARQ involves an encoded forward link for error correction and detection, and a feedback link for possible retransmission. At the transmitter, parity bits are added to a data block which is to be transmitted, the parity bits serving to facilitate detection and correction of errors. In case the receiver is not able to correct these errors, the data block is transmitted again. For each received data block the receiver either sends an ACK (data block is received or decoded successfully) or a NACK (data block is undecodable). The transmitter responds to a NACK by re-transmitting the information.

HARQ is a stop-and-wait protocol. Being a stop-and-wait protocol, (re)transmissions are restricted to occur at known time instants, in between which the sender stops and waits for ACK/NACK feedback from the receiver. As used herein, “feedback” and particularly HARQ feedback includes both feedback of a positive acknowledgement (“ACK”) and feedback of negative acknowledgement (“NACK”). Thus, subsequent transmission of new data can take place only after receiving ACK/NACK from the receiving entity. In case an ACK is received a new transmission occurs, otherwise a retransmission occurs. This scheme can be improved by using multiple channels for supporting HARQ service.

When the HARQ transmitter has reached the maximum number of retransmissions for a transport block without getting an ACK, the HARQ transmitter will stop transmitting and let a higher layer ARQ take over, if any such higher layer ARQ exists. Examples of higher layers that may have ARQ are Radio Link Control (RLC) and Transmission Control Protocol (TCP).

3GPP TS 36.300, Evolved Universal Terrestrial Radio Access (E-UTRA) and Evolved Universal Terrestrial Radio Access Network (E-UTRAN); Overall description; Stage 2, version 10.6.0, sub-clause 9.1 explains some of the principles of LTE HARQ used by 3GPP. For Long Term Evolution (LTE) HARQ, there are several channels of interest, including the Physical Uplink Control Channel (PUCCH); the Physical Uplink Shared Channel (PUSCH); the Physical Downlink Control Channel (PDCCH); and, the Physical Hybrid ARQ Indicator channel (PHICH).

For the downlink, i.e., for transmissions in the downlink (DL), the LTE HARQ is Asynchronous adaptive HARQ. Uplink ACK/NACKs in response to downlink (re)transmissions are sent on PUCCH or PUSCH. PDCCH signals explicitly the HARQ process number and if it is a transmission or retransmission. Retransmissions are always scheduled through PDCCH.

For the uplink, i.e., for transmissions in the uplink (UL), the LTE HARQ is Synchronous HARQ. There are a maximum number of retransmissions configured per UE (as opposed to per radio bearer). Downlink ACK/NACKs in response to uplink (re)transmissions are sent on the PHICH.

In general, HARQ operation on the uplink (UL) is governed by the following basic principles: A first UL HARQ operation principle is that, regardless of the content of the HARQ feedback (ACK or NACK), when a PDCCH for the UE is correctly received, the UE follows what the PDCCH asks the UE to do, e.g., the UE performs a transmission or a retransmission (referred to as adaptive retransmission). A second UL HARQ operation principle is that, when no PDCCH addressed to the C-RNTI of the UE is detected, the HARQ feedback dictates how the UE performs retransmissions. If the HARQ feedback to the UE is a NACK, the UE performs a non-adaptive retransmission, e.g., a retransmission on the same uplink resource as previously used by the same process. If the HARQ feedback to the UE is an ACK, the UE does not perform any UL (re)transmission and keeps the data in a buffer known as the HARQ buffer. A PDCCH is then required to perform a retransmission, e.g., a non-adaptive retransmission cannot follow.

The OSI, or Open System Interconnection, model defines a networking framework for implementing protocols in seven layers. Control is passed from one layer to the next, starting at the application layer in one station, proceeding to the bottom layer, over the channel to the next station and back up the hierarchy. In the second of these layers (Layer 2), data packets are encoded and decoded into bits. Layer 2 furnishes transmission protocol knowledge and management and handles errors in the physical layer, flow control and frame synchronization. The data link layer is divided into two sub layers: The Medium Access Control (MAC) layer and the Radio Link Control (RLC) layer.

3GPP TS 36.321, Evolved Universal Terrestrial Radio Access (E-UTRA); Medium Access Control (MAC) protocol specification, Medium Access Control (MAC) protocol specification, version 10.4.0, sub-clause 5.3.2.2, specifies the E_UTRAN Medium Access Control (MAC) protocol as a sub layer of layer 2. According to this specification, the UE (HARQ receiver over the Downlink Shared Channel [DL-SCH]) is mandated to generate a positive acknowledgement ACK if the data is successfully decoded, otherwise a negative acknowledgement (NACK).

The transmission of ACK/NACK requires that the UE can detect some data transmission. The MAC protocol in 3GPP TS 36.321, version 10.4.0, sub-clause 5.3.1, further specifies that downlink assignments are to be transmitted on the PDCCH to indicate what transmissions are to occur over the Downlink Shared Channel (DL-SCH). Therefore, from the viewpoint of the base station node, e.g., the eNodeB (HARQ transmitter over DL-SCH), there are three results of its HARQ transmission: (1) ACK received; (2) NACK received; and (3) ‘DTX received’ (which implies the detection of no HARQ feedback). There are two reasons why HARQ feedback may be missing, either: (a) UE did not get a chance to detect a DL assignment and could therefore not transmit any ACK/NACK feedback; or (b) UE did transmit feedback, but the feedback from the UE was lost on its way.

3GPP TS 36.322, Evolved Universal Terrestrial Radio Access (E-UTRA); Radio Link Control (RLC) protocol specification, Radio Link Control (RLC) protocol specification, version 10.0.0, specifies the E UTRAN Radio Link Control (RLC) protocol as a sub layer of layer 2. FIG. 1 shows the LTE Layer 2 structure for the downlink (DL); FIG. 2 shows the LTE Layer 2 structure for the uplink (UL). An RLC entity can be configured to perform data transfer in one of the following three modes: (1) RLC Transparent Mode, (2) RLC Unacknowledged Mode (UM), or (3) RLC Acknowledged Mode (AM). The ARQ part is only supported in the RLC Acknowledged Mode.

The Automatic Repeat reQuest (ARQ), in RLC, is an error-control method for data transmission that uses acknowledgements (messages sent by the receiver indicating that it has correctly received the packet) and timeouts (specified periods of time allowed to elapse before an acknowledgment is to be received) to achieve reliable data transmission over an unreliable link. If the sender does not receive an acknowledgment before the timeout, the sender re-transmits the packet at given intervals until the sender either receives an acknowledgment or if the maximum number of retransmissions is exceeded. If the maximum number of re-transmissions is reached, RLC will indicate that to an upper layer (RRC).

FIG. 3 provides an overview of different RLC entities. The mode used by an RLC entity is decided by RRC for each radio bearer and it is signalled from eNodeB to UE at radio bearer setup, as described in 331, Evolved Universal Terrestrial Radio Access (E-UTRA); Radio Resource Control (RRC); Protocol specification, Version 10.4.0.

The RLC UM transmitter may segment and/or concatenate Service Data Units (SDUs) into RLC Protocol Data Units (PDUs). The RLC UM receiver reassembles the SDUs. This gives a higher flexibility to the lower layers which can adapt to whatever transfer possibilities are provided by the scheduler and the radio link. RLC SDUs which have missing segments due to errors in lower layers are discarded by the RLC UM receiver, which also discards duplicates.

The RLC Acknowledged Mode (AM) supports ARQ in addition to the functions described above. The ARQ part makes it possible for missing PDUs or portions of PDUs to be retransmitted. The transmitting side of a RLC AM entity receives status PDUs from its receiver peer informing about which PDU sequence numbers have been received and which have not been received. A PDU that has not been reported as received will be retransmitted after a configured amount of time. Failure to deliver SDUs to higher layers in AM results in RLC delivery failure (determined by a threshold defining maximum number of retransmissions) in the transmitter side, which in turn results in Radio Link Failure (RLF) as specified by 3GPP TS 36.322: subclause 5.2.1 Retransmission and 3GPP TS 36.331, Evolved Universal Terrestrial Radio Access (E-UTRA); Radio Resource Control (RRC); Protocol specification, Version 10.4.0, subclause 5.3.11.3, Detection of radio link failure.

Adding RLC AM ARQ on top of the HARQ decreases the probability of packet loss a lot since status PDUs are CRC-protected and it is therefore very unlikely that an AM RLC entity misinterprets the feedback from its peer, something that can happen more frequently with the single bit feedback used by HARQ. The drawbacks are that retransmissions on the RLC level takes a relatively long time (compared to HARQ retransmissions) since the timer needs to be long enough to give MAC a chance to deliver the status PDU and that all resources used in the initial transmit attempt are wasted (as opposed to HARQ retransmission where soft combining is used). With this in mind, usage of AM RLC is typically restricted to services that are more tolerable to delay than to packet losses.

The “always-on” type of behavior that is often provided for smartphones adds much strain on the battery economy in the UE. There are different methods in LTE to limit the power consumption in the UE; one such method being Discontinuous reception (DRX).

DRX can be applied both in RRC_IDLE and in RRC_CONNECTED, the principles being essentially the same in both states. The description hereafter applies to DRX during RRC_CONNECTED which is the relevant state for the above-mentioned “always-on” type of behavior.

Discontinuous Reception (DRX) is a method to reduce battery consumption in the UE by allowing the UE to stop monitoring the PDCCH. For example, the UE may turn off the receiver during lengthy times and just discontinuously listen during short on-duration phases, which are known to both sides of the protocol. The time periods where the UE is allowed to turn off the receiver are configured by the network and acknowledged by the UE. The reoccurring periods of the on-duration phase are illustrated in FIG. 4.

FIG. 5 illustrates an LTE state model and illustrates various denotations used herein, including “state”, “sub-state”, and “transitions”. FIG. 5 shows, for example, transition paths between RRC_IDLE state and RRC_CONNECTED state and furthermore shows DRX transitions between sub-states while the UE is in RRC_CONNECTED state.

FIG. 5 thus illustrates a conventional view of energy and latency associated to the states and sub-states of LTE:
The more power that is used by the device modem, the faster the device modem will respond to data communication.
Staying in the “Continuous/Active” sub-state is better for having a more immediate connection than staying in the lower DRX sub-states.
Staying in the Short DRX sub-state in turn provides better responsiveness than staying in the Long DRX sub-state.
Staying in RRC_CONNECTED state in turn results in faster reaction (better latency) than staying in the RRC_IDLE state.

FIG. 5 further shows how the energy consumed by the device will change, and suggests that the battery lifetime is shortest when staying all the time in “Continuous/Active” sub-state of RRC_CONNECTED.

DRX involves use of a timers to supervise active reception time. 3GPP TS 36.321, chapter 3 and subclause 5.7, specifies the drx-Inactivity Timer (denoted T1 in FIG. 5) to be the number of consecutive downlink subframe(s) during which the UE shall monitor the PDCCH after successfully decoding a PDCCH indicating an initial UL or DL user data transmission for this UE.

3GPP TS 36.321 also specifies drxShortCycleTimer (denoted T2 in FIG. 5) to be the number of consecutive subframe(s) the UE shall follow the short DRX cycle after the drx-Inactivity Timer has expired. FIG. 6 illustrates the sub-state transitions following upon inactivity. The UE will start the drx-Inactivity Timer each time it terminates and decodes a PDCCH indicating new transmission. The UE will then continue to monitor PDCCH as long as the timer is running, i.e. the drx-Inactivity Timer will keep the UE from falling asleep. After the drx-Inactivity Timer has expired the drxShortCycleTimer is started to supervise a period of responsiveness before switching to the next lower DRX sub-state using Long DRX cycles. The Short DRX cycles are typically much shorter than the Long DRX cycles.

The concept of “Active Time” is also used in DRX. 3GPP TS 36.321, version 10.4.0, chapter 5, subclause 5.7, defines the Active Time as the aggregated phases while either:
on DurationTimer or drx-Inactivity Timer or drx-Retransmission Timer (used to supervise any DL retransmission that UE expects) or mac-ContentionResolutionTimer (used to supervise the completion of random access) is running; or
a Scheduling Request for UL transmission is sent on PUCCH and is pending (no grant for UL transmission has yet been received); or
an uplink grant for a pending HARQ retransmission can occur and there is data in the corresponding HARQ buffer; or
a PDCCH indicating a new transmission addressed to the C-RNTI of the UE has not been received after successful reception of a Random Access Response for the preamble not selected by the UE.

The on DurationTimer mentioned above is a standardized timer that supervises the duration of the on-duration phase.

The use of RLC ARQ over a radio channel may have harsh consequences of delivery failure. The RLC AM mode in 3GPP is based on RLC ARQ and requires timely reports on reception status from the opposite peer. In this regard, RLC AM implies a contract of in-sequence-delivery, and sequence gaps are not tolerated. After a limited period of retransmissions the transmitter judges a gap as permanent and the radio connection is released.

Thus, use of RLC ARQ over a radio channel may cause or present a problem of dropped connections caused by DRX deadlocks. A DRX deadlock exists when the eNodeB and the UE have different views on which is the current DRX sub-state. DRX deadlock is illustrated in FIG. 7. The eNodeB schedules a DL transmission to an UE and sends a DL assignment for new data over PDCCH during the common on-duration phase. But as shown in FIG. 7 the PDCCH information is lost when transmitted over the air. The PDCCH information loss may be for various reasons, such as, e.g. fading dips. As a result, the UE does not detect any PDCCH transmission. In this case, the eNodeB may falsely conclude the UE to be active, e.g., conclude that the UE received the indication of new data. Based on such false conclusions, the eNodeB therefore prolongs the active time by starting its drx-InactivityTimer. At this stage, there is nothing in the MAC or RLC layers that would prevent higher layers from passing data from eNodeB to the UE. After the data is passed from the eNodeB to the UE, however, the eNodeB receives no acknowledgement. The RLC ARQ thus begins retransmission; starts its retransmission timers; and steps (e.g., increments) its retransmission counters. The RLC ARQ will resend PDUs with intervals and counters that are not well matched to the reception phases of the DRX scheme. The RLC layer will eventually reach the threshold for maximum retransmission. As a result, the eNodeB will release the connection and might even drop the UE. Even if the UE is not dropped, these retransmissions on both HARQ and RLC level are done without benefit and have a negative impact on the system throughput, not only in the cell where the deadlock occurs but also in surrounding cells that will be interfered by the fruitless transmission.

### SUMMARY

In one of its aspects the technology disclosed herein concerns a method of operating a base station node of a radio access network. In it basic, generic form the method comprises communicating information over a radio interface between the base station node and a wireless terminal which operates with discontinuous reception (DRX); determining if the base station node is or may become unsynchronized with a current discontinuous reception (DRX) state of the wireless terminal; and, if so, resynchronizing operation or taking preventative action to maintain synchronized operation of the base station node with the current discontinuous reception (DRX) state of the wireless terminal. The basic method may be practiced in either a reactive mode, a proactive mode, or a combined proactive and reactive mode.

In the reactive mode the basic method comprises: determining if the base station node is unsynchronized with the current discontinuous reception (DRX) state of the wireless terminal; and, if so, resynchronizing operation of the base station node with the current discontinuous reception (DRX) state of the wireless terminal.

Resynchronizing operation using the reactive mode may involve or include further acts when unsynchronization is determined. Such further acts may comprise: stopping an ongoing retransmission of information between the base station node and the wireless terminal; and postponing any new transmission of information between the base station node and the wireless terminal.

In an example embodiment resynchronizing operation of the base station node with the current discontinuous reception (DRX) state of the wireless terminal comprises waiting for a next commonly known on-duration phase of discontinuous reception (DRX) operation of the wireless terminal or waiting for an indication of discontinuous reception (DRX) active time from the wireless terminal. In an example implementation the indication of discontinuous reception (DRX) active time from the wireless terminal may comprise an indication of an uplink transmission from the wireless terminal. For example, the indication of discontinuous reception (DRX) active time from the wireless terminal may comprise a detection of an uplink transmission on a Physical Uplink Shared Channel (PUSCH) from the wireless terminal or a new random access attempt by the wireless terminal.

In its reactive mode the basic method may determine that the base station node is unsynchronized with the current discontinuous reception (DRX) state of the wireless terminal using different unsynch determination techniques. One example technique comprises determining that the base station node is unsynchronized with the current discontinuous reception (DRX) state of the wireless terminal by determining lack of HARQ feedback on a Physical Uplink Control Channel (PUCCH) from the wireless terminal after the base station node has scheduled a downlink transmission to the wireless terminal. When such “missing HARQ” technique is employed, the method may further comprise actions such as: stopping any ongoing retransmission of information from the base station node to the wireless terminal; postponing any new transmission of information from the base station node to the wireless terminal; stopping or postponing any radio link control (RLC) layer retransmissions from the base station to the wireless terminal; and stopping scheduling uplink transmissions from the wireless terminal to the base station node.

Another unsynch determination technique comprises determining that the base station node is unsynchronized with the current discontinuous reception (DRX) state of the wireless terminal by determining lack of reception on a Physical Uplink Shared Channel (PUSCH) from the wireless terminal after the base station node has scheduled an uplink transmission from the wireless terminal.

When such “missing PUSCH” technique is employed, the method may further comprise actions such as: stopping scheduling uplink transmissions from the wireless terminal to the base station node; and, postponing any new transmission of information from the base station node to the wireless terminal.

Another unsynchronization determination technique is a combination of the “missing HARQ” and “missing PUSCH” techniques. That is, determining that the base station node is unsynchronized with the current discontinuous reception (DRX) state of the wireless terminal comprise both: (1) determining lack of HARQ feedback on a Physical Uplink Control Channel (PUCCH) from the wireless terminal after the base station node has scheduled a downlink transmission to the wireless terminal; and (2) determining lack of reception on a Physical Uplink Shared Channel (PUSCH) from the wireless terminal after the base station node has scheduled an uplink transmission from the wireless terminal.

Regardless of what determination technique is employed, in an optional further embodiment the method may further comprise receiving channel quality measurements from the wireless terminal and using the channel quality measurements to confirm unsynchronization of the base station node with the current discontinuous reception (DRX) state of the wireless terminal.

In the proactive mode the basic method comprises: determining if the base station may become unsynchronized with the current discontinuous reception (DRX) state of the wireless terminal; and, if so, taking preventative action to maintain synchronized operation of the base station node with the current discontinuous reception (DRX) state of the wireless terminal.

In an example embodiment of the proactive mode, determining if the base station node may become unsynchronized with the current discontinuous reception (DRX) state of the wireless terminal comprises monitoring a coverage level on a downlink (DL) from the base station node to the wireless terminal. In an example implementation, monitoring the coverage level on the downlink (DL) comprises monitoring at least one of received signal received power (RSRP), received signal received quality (RSRQ), and channel quality index (CQI).

The proactive mode includes one or more acts of taking preventative action to maintain synchronized operation of the base station node with the current discontinuous reception (DRX) state of the wireless terminal. In one example embodiment the preventive action comprises increasing robustness (e.g., energy) of a HARQ transmission which contains an initial DL assignment. In another example embodiment the preventive action comprises changing configuration of the discontinuous reception (DRX). In an example implementation of such embodiment changing configuration of the discontinuous reception (DRX) may involve by at least one of increasing an on-duration phase, increasing a value of a drx-InactivityTimer; and, shortening Long DRX cycles. In another example embodiment the preventive action comprises aligning RLC by transmitting and retransmitting PDUs with intervals and counters matched to reception phases of the DRX scheme.

In an example embodiment, the method further comprises: determining if, despite the preventative action, the base station node becomes unsynchronized with the current discontinuous reception (DRX) state of the wireless terminal; and, if so, resynchronizing operation of the base station node with the current discontinuous reception (DRX) state of the wireless terminal.

In an example embodiment the proactive mode may also be implemented without requiring measurement or input from a wireless terminal to trigger preventative action.

In another aspect the technology disclosed herein concerns a method of operating a base station node of a radio access network which communicates across an air or radio interface with a wireless terminal which operates with discontinuous reception (DRX). The base station node comprises a logic processing circuit configured to determine if the base station node is or may become unsynchronized with a current discontinuous reception (DRX) state of the wireless terminal, and to resynchronize operation or take preventative action to maintain synchronized operation of the base station node with the current discontinuous reception (DRX) state of the wireless terminal.

The base station node may operate in a reactive mode, a proactive mode, or a combination of reactive and proactive modes. In the reactive mode the logic processing circuit is configured to determine if the base station node is unsynchronized with the current discontinuous reception (DRX) state of the wireless terminal and to resynchronize operation of the base station node with the current discontinuous reception (DRX) state of the wireless terminal. In the reactive embodiment the base station node may employ either a “missing HARQ” unsynchronization detection technique or a “missing PUSCH” unsynchronization detection technique. In an embodiment using the “missing HARQ” unsynchronization detection technique the logic processing circuit is configured to determine if the base station node is unsynchronized with the current discontinuous reception (DRX) state of the wireless terminal by determining lack of HARQ feedback on a Physical Uplink Control Channel (PUCCH) from the wireless terminal after the base station node has scheduled a downlink transmission to the wireless terminal. If it is determined that the base station node is unsynchronized with the current discontinuous reception (DRX) state of the wireless terminal, the logic processing circuit is further configured to: stop any ongoing retransmission of information from the base station node to the wireless terminal; postpone any new transmission of information from the base station node to the wireless terminal; stop or postpone any radio link control (RLC) layer retransmissions from the base station to the wireless terminal; and stop scheduling uplink transmissions from the wireless terminal to the base station node.

In the proactive mode the logic processing circuit is configured to determine if the base station node is unsynchronized with the current discontinuous reception (DRX) state of the wireless terminal by determining lack of a reception on a Physical Uplink Shared Channel (PUSCH) from the wireless terminal after the base station node has scheduled an uplink transmission from the wireless terminal. If it is determined that the base station node is unsynchronized with the current discontinuous reception (DRX) state of the wireless terminal, the logic processing circuit is configured to: stop scheduling uplink transmissions from the wireless terminal to the base station node; and postpone any new transmission of information from the base station node to the wireless terminal.

In an example embodiment the logic processing circuit is configured to receive channel quality measurements from the wireless terminal and to use the channel quality measurements to confirm unsynchronization of the base station node with the current discontinuous reception (DRX) state of the wireless terminal.

In the proactive mode the logic processing circuit is configured to: determine if the base station may become unsynchronized with the current discontinuous reception (DRX) state of the wireless terminal; and, if so, take preventative action to maintain synchronized operation of the base station node with the current discontinuous reception (DRX) state of the wireless terminal.

In an example embodiment of the proactive mode the logic processing circuit is configured to determine if the base station node may become unsynchronized with the current discontinuous reception (DRX) state of the wireless terminal by monitoring a coverage level on a downlink (DL) from the base station node to the wireless terminal.

In an example embodiment of the proactive mode the logic processing circuit is configured to take preventive action by performing at least one of the following: increase robustness of a HARQ transmission which contains an initial DL assignment; change configuration of the discontinuous reception (DRX); and align RLC by transmitting and retransmitting PDUs with intervals and counters matched to reception phases of the DRX scheme.

In an example embodiment the logic processing circuit is configured to determine if, despite the preventative action, the base station node becomes unsynchronized with the current discontinuous reception (DRX) state of the wireless terminal; and, if so, to resynchronize operation of the base station node with the current discontinuous reception (DRX) state of the wireless terminal.

In another aspect the technology disclosed herein concerns a method of operating a base station node which communicates over a radio interface with a wireless terminal served by the base station node, the wireless terminal operating with discontinuous reception (DRX). The base station node comprises a logic processing circuit configured to take preventative action to maintain synchronized operation of the base station node with the current discontinuous reception (DRX) state of the wireless terminal. Such preventative action may comprise, for example: increasing robustness of a HARQ transmission which contains an initial DL assignment; changing configuration of the discontinuous reception (DRX); and aligning RLC by transmitting and retransmitting PDUs with intervals and counters matched to reception phases of the DRX scheme.

In another aspect the technology disclosed herein concerns a method of operating a wireless terminal which communicates with a base station node of a radio access network. In a basic embodiment the method of operating the wireless terminal comprises reporting, to the base station node, indications of downlink coverage based on trigger events configured for facilitating DRX management; and receiving instructions for combating DRX deadlock and implementing those instructions.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view illustrating Layer 2 structure for LTE downlink (DL).

FIG. 2 is a diagrammatic view illustrating Layer 2 structure for uplink (UL).

FIG. 3 is a diagrammatic view illustrating RLC entities of Layer 2.

FIG. 4 is a diagrammatic view illustrating a Discontinuous Reception (DRX) cycle according to an example embodiment.

FIG. 5 is a diagrammatic view illustrating states, sub-states, and transitions of LTE with respect to energy and latency.

FIG. 6 is a diagrammatic view illustrating, e.g., transitions following inactivity from continuous/active to DRX using short DRX cycles and then to DRX using long DRX cycles.

FIG. 7 is a diagrammatic view illustrating, e.g., DRX deadlock occurring in view of lack of HARQ feedback.

FIG. 8 is a schematic view of an example telecommunications system and particularly illustrates portions of a radio access network which combats DRX deadlock.

FIG. 9 is a flowchart illustrating basic or representative acts or steps of a generic method of combating DRX deadlock.

FIG. 10 is a flowchart illustrating basic acts or steps involved in a generic example reactive mode.

FIG. 11 is a flowchart illustrating basic acts or steps involved in a resynchronizing operation using the reactive mode according to an example embodiment.

FIG. 12 is a diagrammatic view of a decision process for handling DRX deadlock in accordance with a reactive missing “HARQ” mode.

FIG. 13 is a diagrammatic view of DRX resynchronization to a next commonly known on-duration phase in accordance with an example reactive “missing HARQ” embodiment.

FIG. 14 is a diagrammatic view of DRX resynchronization to an indication of DRX active time in accordance with an example reactive “missing HARQ” embodiment.

FIG. 15 is a schematic view of a non-limiting example embodiment of a base station node and a wireless terminal arranged for using the reactive mode which employs a “missing HARQ” DRX deadlock detection technique.

FIG. 16 is a flowchart illustrating basic acts or steps comprising a method of operating a base station node which employs a “missing HARQ” DRX deadlock detection technique.

FIG. 17 is a diagrammatic view of DRX resynchronization to a next commonly known part of active time: the occurrence of on-duration phase, in accordance with an example reactive “missing PUSCH” embodiment.

FIG. 18 is a diagrammatic view of DRX resynchronization to a next commonly known part of active time: a certified detection of transmission of SR on PUCCH, in accordance with an example reactive “missing PUSCH” embodiment.

FIG. 19 is a diagrammatic illustrating DRX resynchronization to a next commonly known part of active time: a certified detection of random access, in accordance with an example reactive missing “PUSCH” embodiment.

FIG. 20 is a schematic view of a non-limiting example embodiment of a base station node and a wireless terminal arranged for using the reactive mode which employs a “missing PUSCH” DRX deadlock detection technique.

FIG. 21 is a flowchart illustrating basic acts or steps comprising a method of operating a base station node which employs a “missing PUSCH” DRX deadlock detection technique.

FIG. 22 is a schematic view of a non-limiting example embodiment of a base station node and a wireless terminal arranged for using the reactive mode which employs both a “missing HARQ” DRX deadlock detection technique and a “missing PUSCH” DRX deadlock detection technique.

FIG. 23 is a flowchart illustrating basic acts or steps comprising a method of operating a base station node which employs both a “missing HARQ” DRX deadlock detection technique and a “missing PUSCH” DRX deadlock detection technique.

FIG. 24 is a flowchart illustrating basic acts or steps comprising a method of operating a base station node which employs channel quality measurements to confirm unsynchronization of the base station node with the current discontinuous reception (DRX) state of a wireless terminal.

FIG. 25 is a flowchart illustrating basic acts or steps involved in a generic example proactive mode.

FIG. 26 is a flowchart illustrating basic acts or steps involved in an example proactive mode which includes monitoring a coverage level on a downlink.

FIG. 27 is a diagrammatic view depicting example preventative actions of a proactive mode.

FIG. 28 is a schematic view of a non-limiting example embodiment of a base station node and a wireless terminal arranged for using the proactive mode and wherein preventive action comprises changing configuration of the discontinuous reception (DRX).

FIG. 29 is a schematic view of a non-limiting example embodiment of a base station node and a wireless terminal arranged for using the proactive mode and wherein preventive action comprises increasing robustness of a first transmission.

FIG. 30 is a schematic view of a non-limiting example embodiment of a base station node and a wireless terminal arranged for using the proactive mode and wherein preventive action comprises aligning RLC.

FIG. 31 is a flowchart illustrating basic acts or steps involved in an example embodiment which combines features of the proactive mode and the reactive mode.

FIG. 32 is a flowchart illustrating basic acts or steps involved in an example proactive mode which does not require measurement or input from a wireless terminal to trigger preventative action.

FIG. 33 is a flowchart illustrating basic acts or steps involved in an example mode of operating a wireless terminal according to an example embodiment.

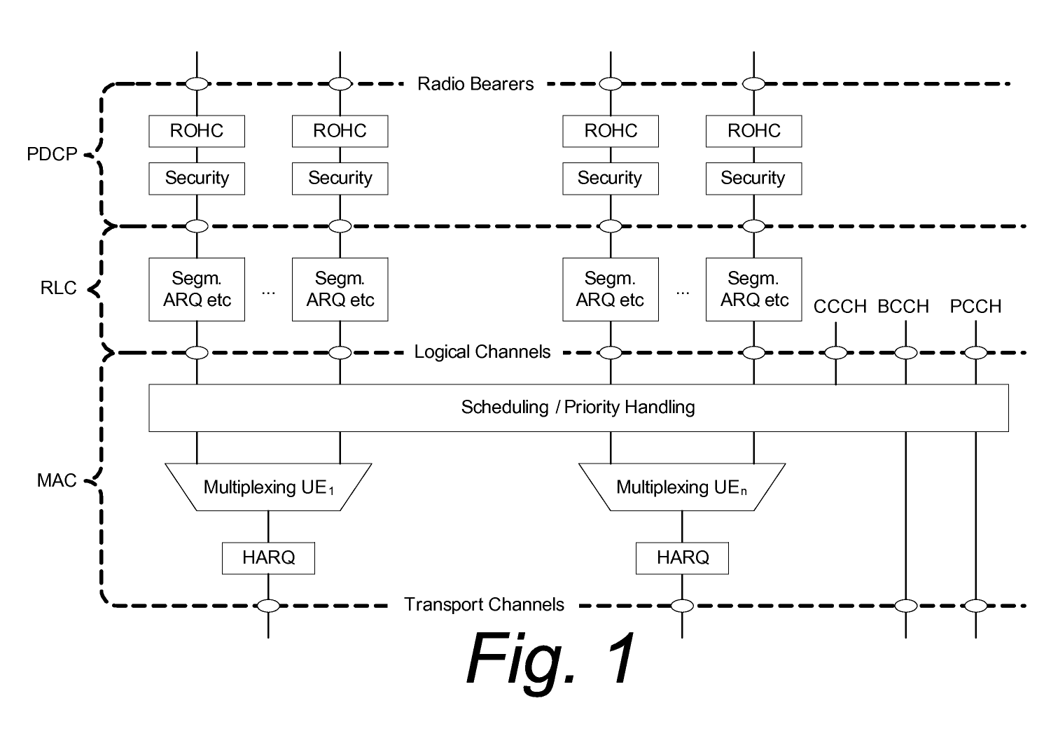

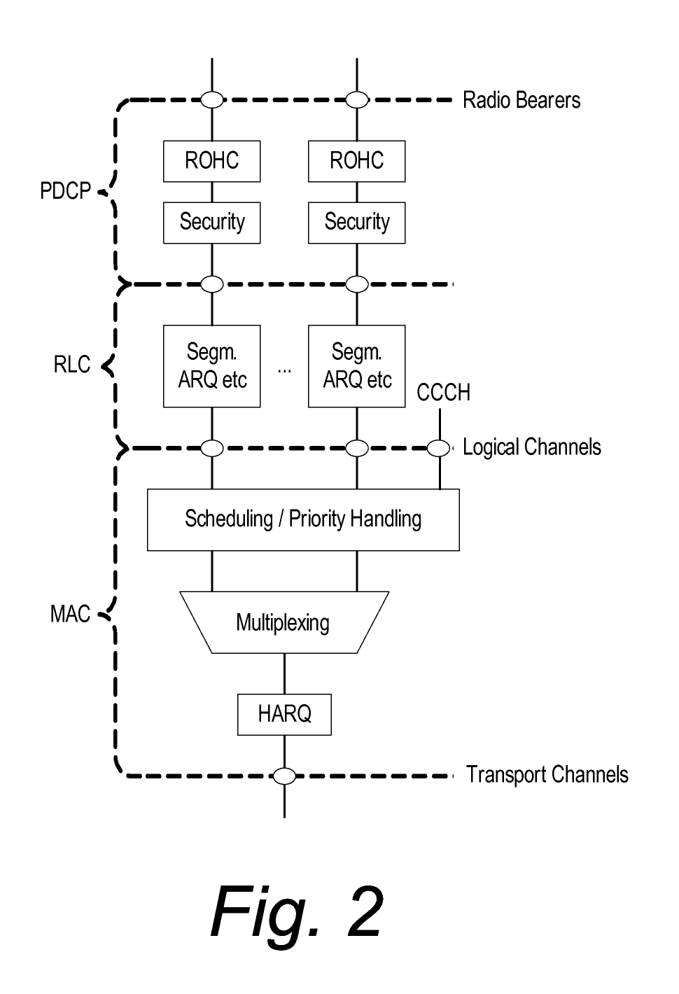

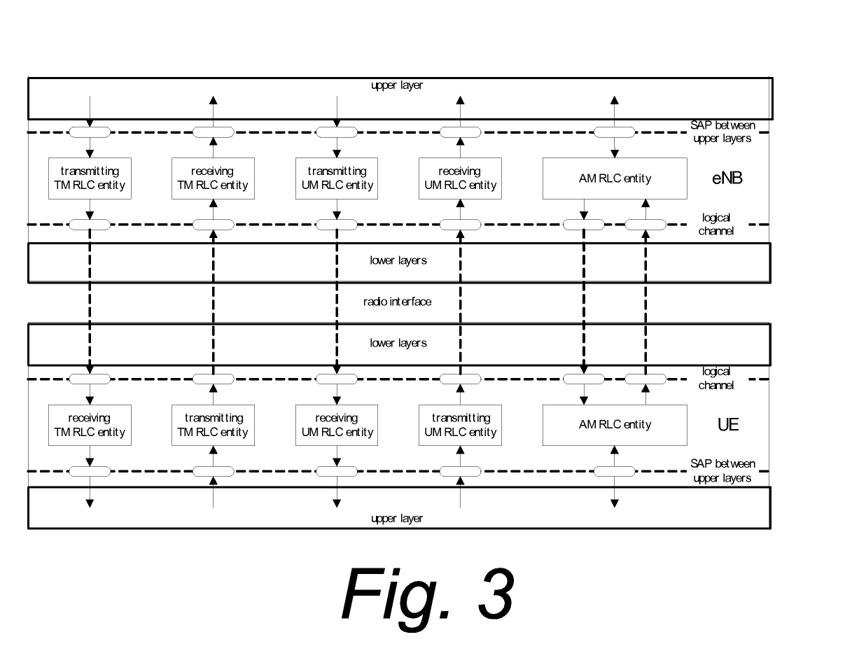

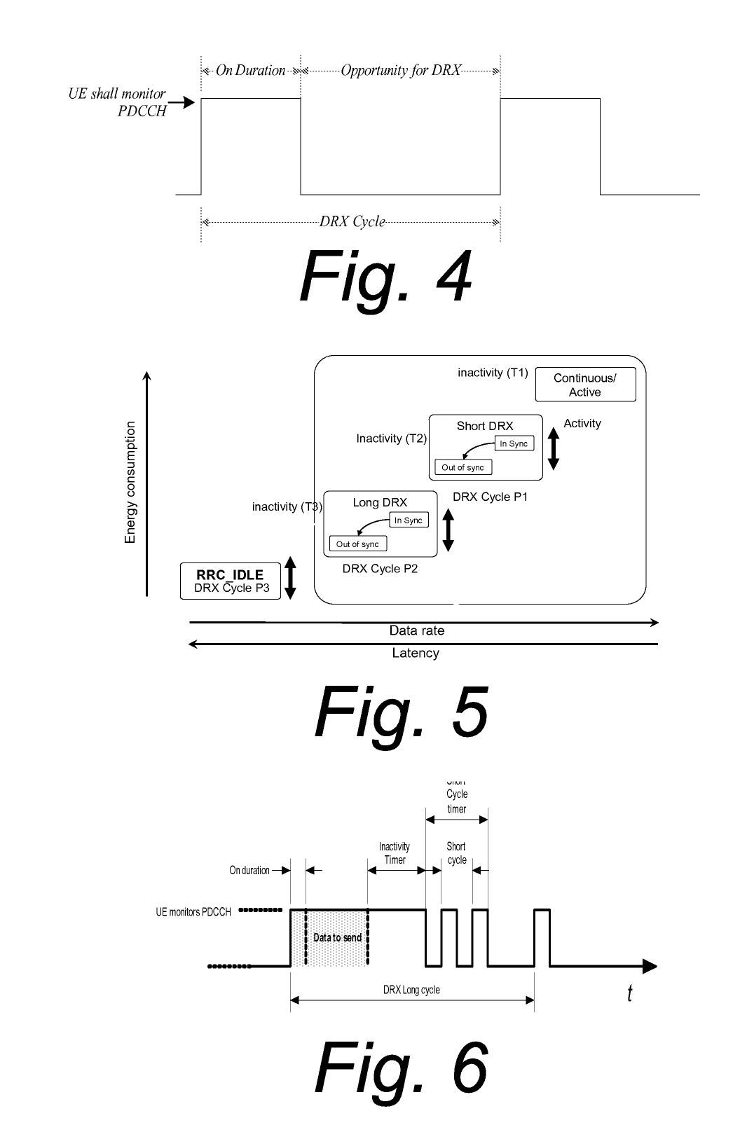

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

As used herein, the term “node” may encompass nodes using any technology including, e.g., high speed packet access (HSPA), long term evolution (LTE), code division multiple access (CDMA)2000, GSM, etc. or a mixture of technologies such as with a multi-standard radio (MSR) node (e.g., LTE/HSPA, GSM/HS/LTE, CDMA2000/LTE etc). Furthermore the technology described herein may apply to different types of nodes e.g., base station, eNode B, Node B, relay, base transceiver station (BTS), donor node serving a relay node (e.g., donor base station, donor Node B, donor eNB), supporting one or more radio access technologies.

Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Combating DRX Deadlock: Generic Structure and Operation

The technology disclosed herein seeks, e.g., to combat discontinuous reception (DRX) deadlock. As mentioned above, a DRX deadlock exists when the eNodeB and the UE have different views on what is the current DRX sub-state. As used herein, “combating” DRX deadlock comprises both prevention of potential DRX deadlock situations (e.g., before DRX deadlock actually occurs) and resolution of actual DRX deadlock by counteractive measures such as, e.g., resynchronization.

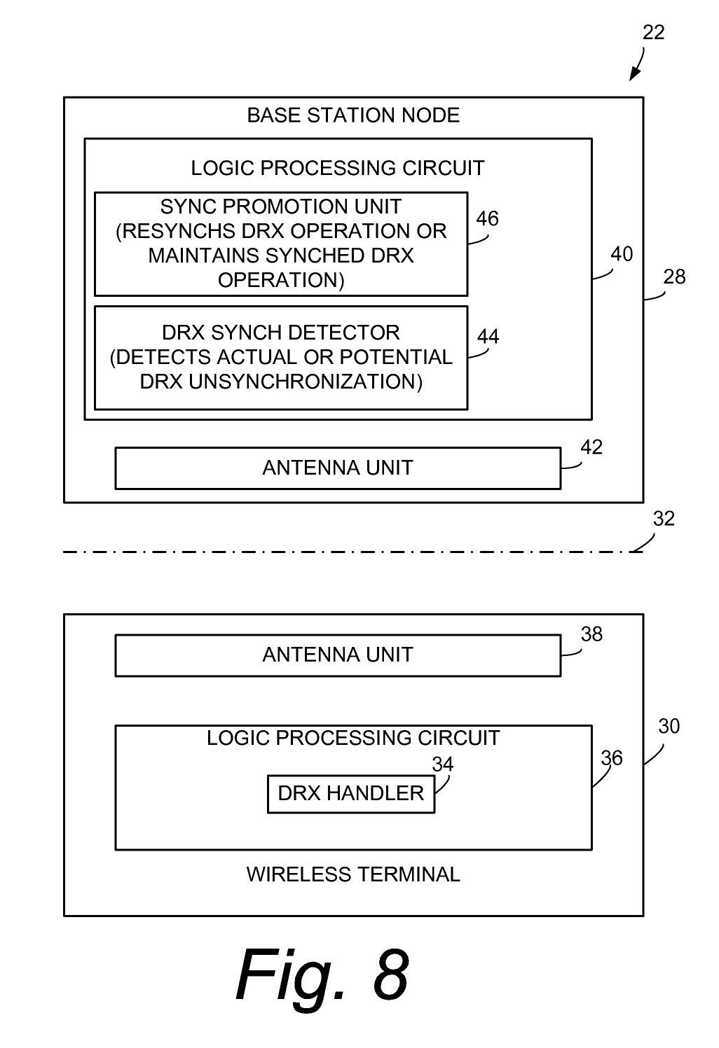

FIG. 8 illustrates an example telecommunications system and particularly illustrates portions of a radio access network 22. The radio access network 22 includes one or more base station nodes, such as representative base station node 28. The base station node 28 communicates with one or more wireless terminals (such as representative wireless terminal 30) over an air or radio interface 32.

The wireless terminal 30 is of a type that can operate, e.g. selectively operate, using discontinuous reception (DRX), for which reason wireless terminal 30 is illustrated in FIG. 8 as comprising DRX handler 34. In the example embodiment of FIG. 8 the DRX handler 34 may be realized by or comprise a processing entity denominated as logic processing circuit 36. The wireless terminal 30 also comprises antenna unit 38 which facilitates, e.g., reception and transmission of communications across radio interface 32 with base station node 28. The wireless terminal may be called by other names and comprise different types of equipment. For example, the wireless terminal can also be called a mobile station, wireless station, or user equipment unit (UE), and can be equipment such as a mobile telephone (“cellular” telephone) and a laptop with mobile termination, and thus can be, for example, portable, pocket, hand-held, computer-included, or car-mounted mobile devices which communicate voice and/or data with radio access network.

The base station node 28 similarly comprises logic processing circuit 40 and antenna unit 42. As used herein, either with respect to wireless terminal 30 or base station node 28, “logic processing circuit” may comprise one or more processors or controllers as those terms are herein expansively defined. Moreover, an “antenna unit” includes not only one or more radio antenna, but also equipment suitable for pre-conditioning signals prior to transmission over the radio interface 32 (such as modulators, etc.) as well as equipment for processing signals received over radio interface 32 (such as demodulators, etc.), e.g., suitable radio communications circuitry.

The base station node 28 also comprises DRX synch detector 44 and sync promotion unit 46. In an example embodiment both DRX synch detector 44 and sync promotion unit 46 may be realized or implemented by logic processing circuit 40. The DRX synch detector 44 serves to determine if the base station node is or may become unsynchronized with a current discontinuous reception (DRX) state of the wireless terminal. If such a determination of actual or potential unsynchronization is made by DRX synch detector 44, the sync promotion unit 46 serves one or both of the following functions: (1) resynchronizing operation of the base station node with the current discontinuous reception (DRX) state of the wireless terminal; (2) take preventative action to maintain synchronized operation of the base station node with the current discontinuous reception (DRX) state of the wireless terminal.

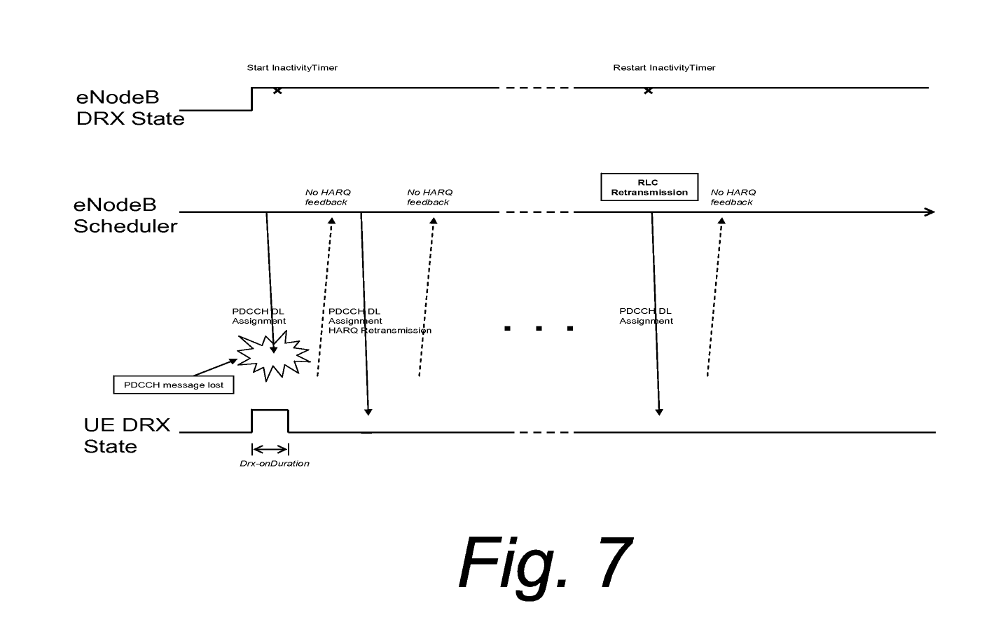

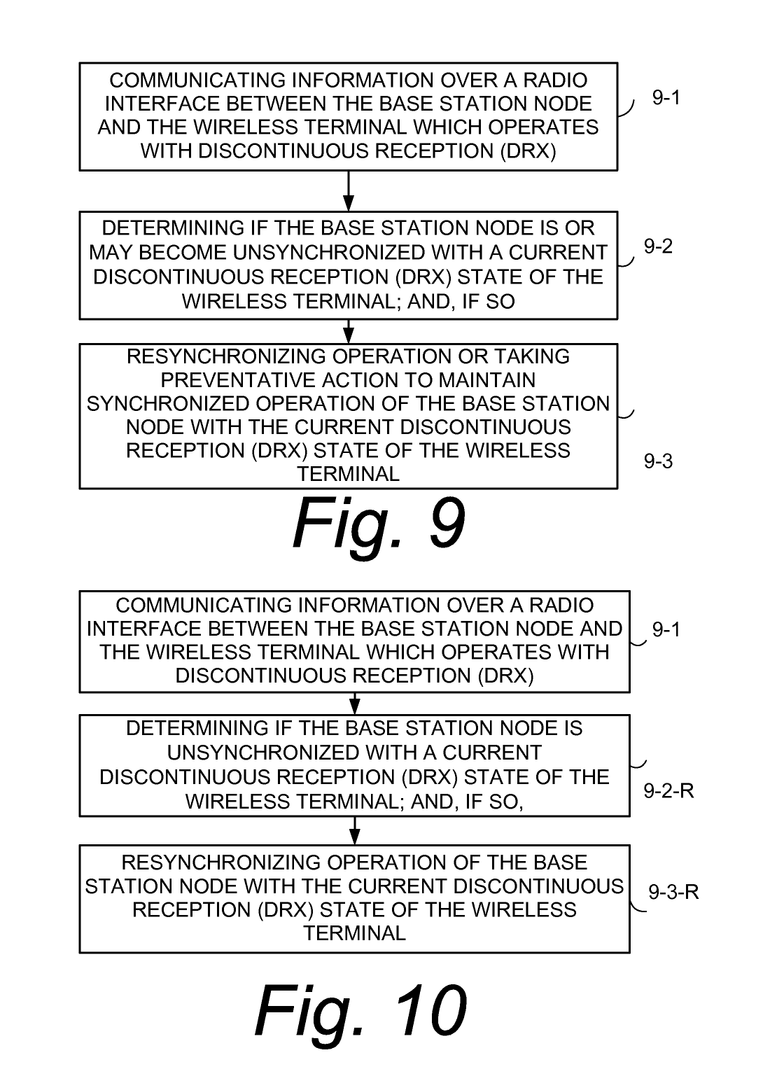

The technology disclosed herein thus also includes a method of operating a base station node such as base station node 28. Basic or representative acts or steps of a generic method are illustrated in FIG. 9. Act 9-1 comprises communicating information over the radio interface 32 between the base station node 28 and the wireless terminal 30 (the wireless terminal 30 operates with discontinuous reception (DRX)). Act 9-2 comprises determining if the base station node 28 is or may become unsynchronized with a current discontinuous reception (DRX) state of the wireless terminal. Act 9-3 comprises resynchronizing operation or taking preventative action to maintain synchronized operation of the base station node with the current discontinuous reception (DRX) state of the wireless terminal. Thus, base station node 28 can predict or detect inconsistent views on DRX sub-state between the wireless terminal 30 and the base station node 28. The technology disclosed herein thus proactively prevents or reactively resolves situations such as those described above, e.g., with reference to FIG. 7.

Combating DRX Deadlock: Reactive Modes

As described further herein, the basic method may be practice in either a reactive mode, a proactive mode, or a combined proactive and reactive mode. FIG. 10 illustrates basic acts or steps involved in the reactive mode. The basic acts or steps of FIG. 10 resemble those of FIG. 9 except that the act 9-2-R and act 9-3-R implement only the first alternative subacts of 9-2 and act 9-3, respectively. That is, act 9-2-R comprises determining if the base station node is unsynchronized with the current discontinuous reception (DRX) state of the wireless terminal. If so, the reactive method further includes act 9-3-R, e.g., resynchronizing operation of the base station node with the current discontinuous reception (DRX) state of the wireless terminal.

Thus, in an example embodiment the reactive mode includes solutions to detect DRX deadlock and where the detection itself causes a transmission break; followed by a period of re-synchronization using common phases and indicators of the DRX active time. In an example implementation the reactive mode monitors indications of DRX deadlock and takes actions to resynchronize DRX when sufficient evidence is gathered, e.g., an approach that halts or postpones transmission to the next common phase at the same time as it monitors indications of DRX active time.

When an indication of DRX deadlock occurs, in the reactive mode base station node 28 will stop any ongoing retransmission, postpone any new transmission and instead try to re-sync the DRX state with the wireless terminal 30, by waiting for the next predefined common phase or indication of DRX active time.

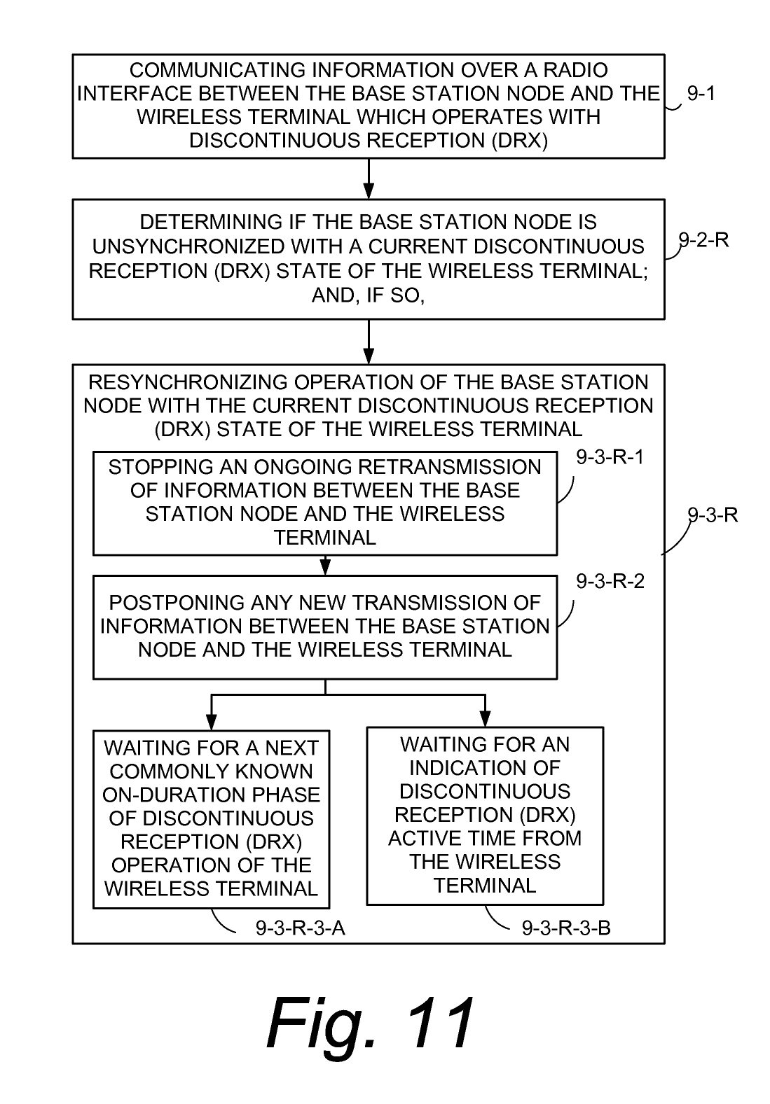

In the above regard, and as shown in FIG. 11, act 9-3-R of resynchronizing operation using the reactive mode may involve or include further acts. Such further acts may comprise act 9-3-R-1, and 9-3-R-2, and either one of act 9-3-R-3-A or act 9-3-R-3-B of FIG. 11. Act 9-3-R-1 comprises stopping an ongoing retransmission of information between the base station node and the wireless terminal. Act 9-3-R-2 comprises postponing any new transmission of information between the base station node and the wireless terminal. Act 9-3-R-3-A comprises waiting for a next commonly known on-duration phase of discontinuous reception (DRX) operation of the wireless terminal, whereas act 9-3-R-3-B comprises or waiting for an indication of discontinuous reception (DRX) active time from the wireless terminal. In an example implementation the indication of discontinuous reception (DRX) active time from the wireless terminal may comprises an indication of an uplink transmission from the wireless terminal. For example, the indication of discontinuous reception (DRX) active time from the wireless terminal may comprise an uplink transmission on a Physical Uplink Shared Channel (PUSCH) from the wireless terminal or a new random access attempt by the wireless terminal.

In its reactive mode the basic method may determine that the base station node is unsynchronized with the current discontinuous reception (DRX) state of the wireless terminal using different unsynchronization determination techniques. That is, the base station node 28 may use different input or lack of input to determine if a situation has arisen in which base station node 28 and wireless terminal 30 have different views of which is the current DRX sub-state.

Combating DRX Deadlock: Reactive Modes: Detecting Missing HARQ

One example unsynchronization determination technique comprises determining that the base station node is unsynchronized with the current discontinuous reception (DRX) state of the wireless terminal by determining lack of HARQ feedback on a Physical Uplink Control Channel (PUCCH) from the wireless terminal after the base station node has scheduled a downlink transmission to the wireless terminal.

DL-SCH is a transport channel which is mapped to PDSCH on the physical layer. PDCCH is another physical channel. In general, a downlink (DL) assignment occurs over PDCCH, and signals a grant (see, e.g., Format lA in 3GPP TSs 36.211/212/213) and the grant includes the resource block assignment, e.g., a reference to PDSCH were the data occurs. PDCCH and PDSCH occur simultaneously.

FIG. 7 illustrates one way for base station node 28 to detect a DRX deadlock. As described above, the 3GPP standard mandates the wireless terminal to: detect and decode any DL-SCH transmission that occurs during the on-duration phase; at detection of a new DL transmission or a DL retransmission to start the HARQ RTT timer and to transmit HARQ feedback; at detection of a new transmission start its drx-InactivityTimer; remains active while drx-InactivityTimer is running. Therefore, the base station node 28 can use any lasting lack of HARQ feedback on PUCCH as a good indication of a DRX deadlock. The reason for lack of feedback can be that the radio channel for PDCCH is either continuously bad or was just momentarily bad during the brief on-duration phase. In either case, the wireless terminal did not detect the start of the DL-SCH transmission and resides now in a phase where it again has disrupted its reception.

What causes the base station to start its drx-inactivity Timer is generally up to vendor implementation (not standardized) and therefore could be different from node to node. For example, the staring could be the sending of new data, but this alone is not failsafe since base station would not know if new data arrives to the wireless terminal 30. The starting could also be the reception of HARQ ACK, but also that will suffer from some uncertainty. If the data sent is sent using RLC AM, the start of timer could be the reception of RLC ACK. In any event, the start of the drx-inactivity Timer of the base station node 28 should be as close to the arrival of new data as possible, and the “timer start” may be adjusted with the additional roundtrip time from sending DL assignment until trigger to start occurs.

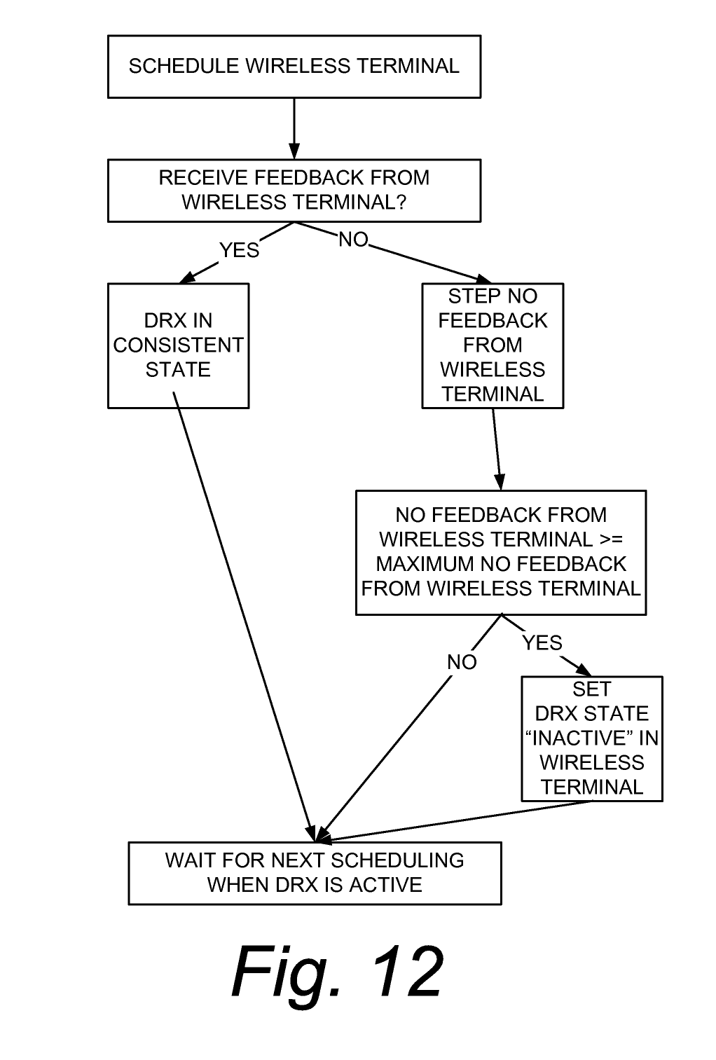

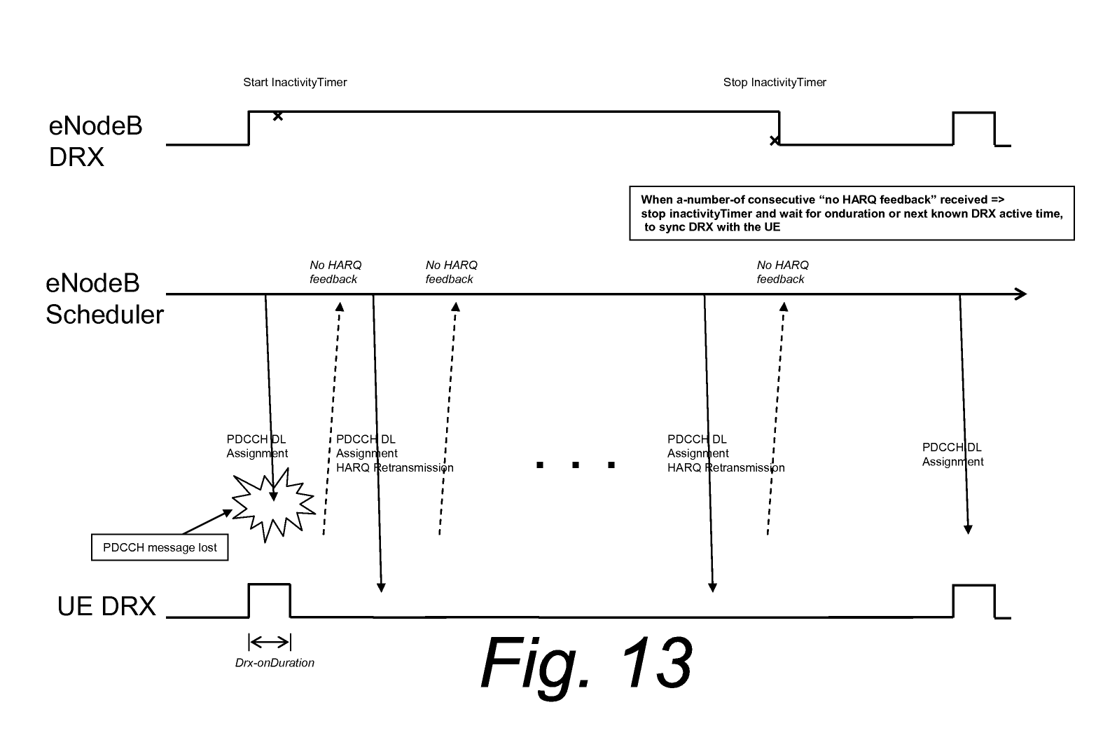

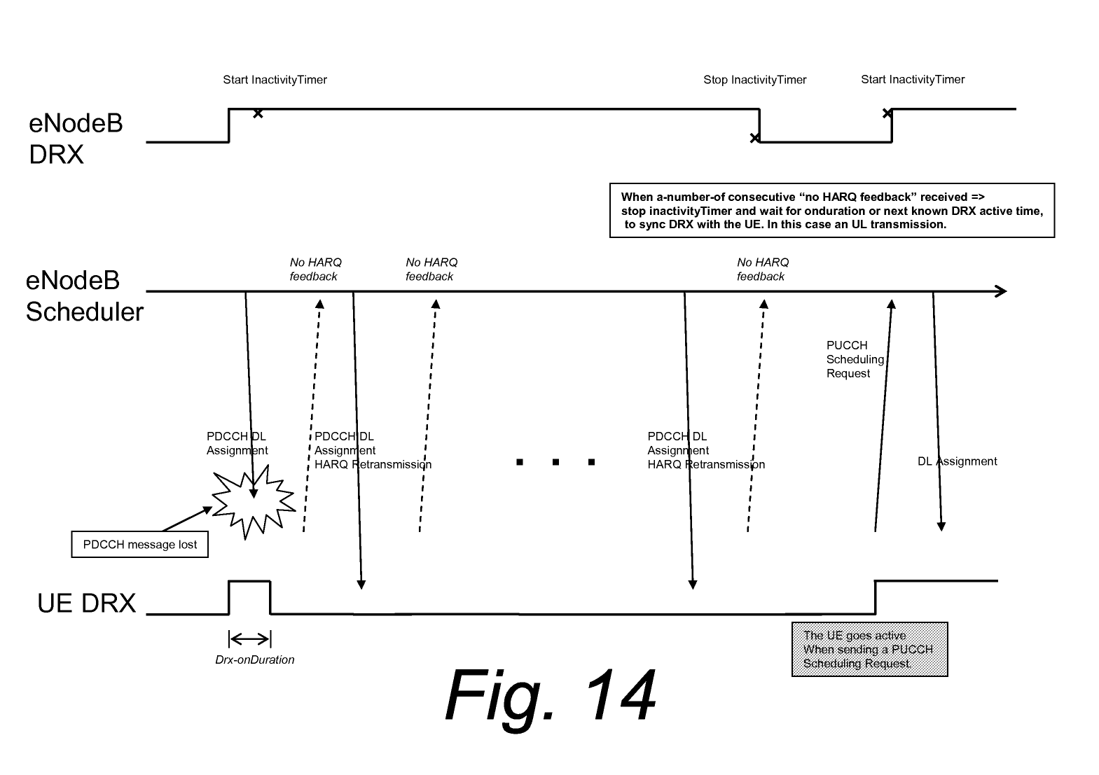

FIG. 12 describes a decision process to handle a situation which arises from the DRX deadlock portrayed, e.g., by FIG. 7. When the base station node 28 has scheduled the wireless terminal 30 without receiving any HARQ feedback during a configured value of max-transmissions-without-HARQ-Feedback, the base station node 28 stops scheduling this no-feedback wireless terminal 30 since the base station node 28 now has reason to believe that the wireless terminal 30 is likely not in a receptive phase. The base station node 28 stops the internal running drx-inactivityTimer and any ongoing transmission; postpones transmission of new data and also RLC layer retransmissions; and stops further grants for UL-SCH transmission. The base station node 28 then waits for the next possibility to resynchronize DRX, e.g., to the next common phase or indication of DRX active time. In this regard, FIG. 13 illustrates DRX resync to the next commonly known on-duration phase. The next known DRX active time can also be caused by an indication of UL transmission as illustrated by FIG. 14.

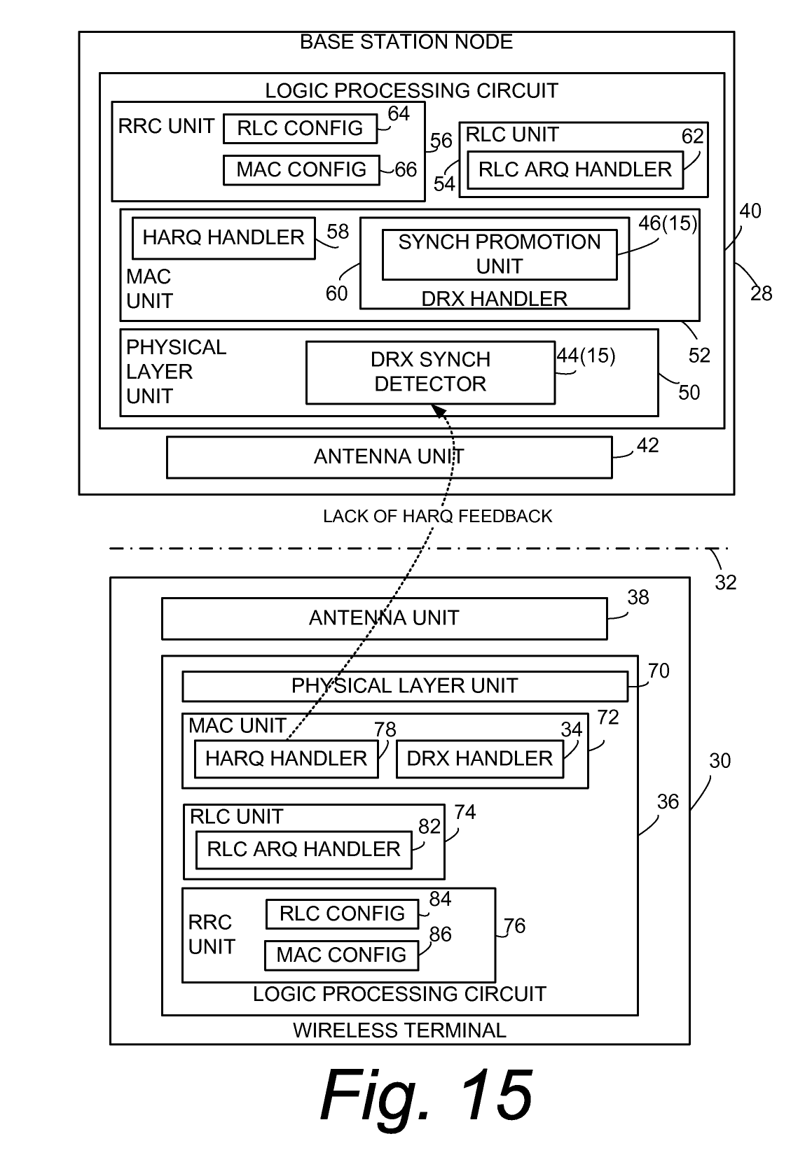

FIG. 15 shows a non-limiting example implementation of base station node 28 and wireless terminal 30 arranged for using the reactive mode which employs the “missing HARQ” DRX deadlock detection technique. As shown in FIG. 15, base station node 28 comprises physical layer unit 50, medium access control (MAC) unit 52; radio link control (RLC) unit 54; and radio resource control (RRC) unit 56. The medium access control (MAC) unit 52 in turn comprises both HARQ handler 58 and DRX handler 60. The radio link control (RLC) unit 54 comprises RLC ARQ handler 62. The radio resource control (RRC) unit 56 configures both MAC (HARQ and DRX) and RLC, and thus includes RLC configuration unit 64 and MAC configuration unit 66. In an example embodiment, each of physical layer unit 50, medium access control (MAC) unit 52, radio link control (RLC) unit 54, and radio resource control (RRC) unit 56, as well as their constituent units, may be realized or comprise logic processing circuit 40.

FIG. 15 further shows wireless terminal 30 as comprising physical layer unit 70; medium access control (MAC) unit 72; radio link control (RLC) unit 74; and radio resource control (RRC) unit 76. The medium access control (MAC) unit 72 in turn comprises both HARQ handler 78 and DRX handler 34. The radio link control (RLC) unit 74 comprises RLC ARQ handler 82. The radio resource control (RRC) unit 76 configures both MAC (HARQ and DRX) and RLC, and thus includes RLC configuration unit 84 and MAC configuration unit 86. In an example embodiment, each of physical layer unit 70, medium access control (MAC) unit 72, radio link control (RLC) unit 74, and radio resource control (RRC) unit 76, as well as their constituent units, may be realized or comprise logic processing circuit 36.

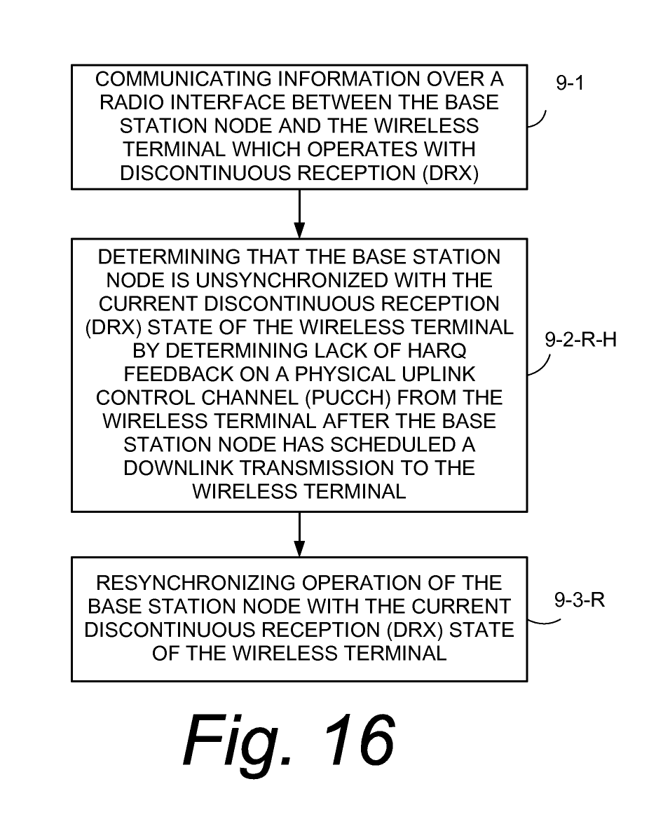

FIG. 16 illustrates example acts or steps included in a method of operating a base station node which employs the “missing HARQ” DRX deadlock detection technique. Acts 9-1 and 9-3-R of FIG. 16 are the same as those of FIG. 9. Act 9-2-R-H of FIG. 16, which follows act 9-1, comprises determining that the base station node is unsynchronized with the current discontinuous reception (DRX) state of the wireless terminal by determining lack of HARQ feedback on a Physical Uplink Control Channel (PUCCH) from the wireless terminal after the base station node has scheduled a downlink transmission to the wireless terminal. FIG. 15 shows by a dotted line the missing HARQ feedback, which would otherwise have emanated from HARQ handler 78 of wireless terminal 30.

In the FIG. 15 reaction mode embodiment physical layer unit 50 hosts DRX synch detector 44(15) and DRX handler 60 hosts sync promotion unit 46(15). The physical layer unit 50 interacts with the HARQ handler 58, e.g. physical layer unit 50 makes HARQ handler 58 stop or postpone ongoing (re)transmission. DRX synch detector 44(15) performs act 9-2-R-H and sync promotion unit 46(15) performs act 9-3-R.

When such “missing HARQ” technique is employed, the method may further comprise actions such as: stopping any ongoing (HARQ) retransmission of information from the base station node to the wireless terminal; postponing any new (HARQ) transmission of information from the base station node to the wireless terminal; stopping or postponing any radio link control (RLC) layer retransmissions from the base station to the wireless terminal; and stopping scheduling uplink transmissions from the wireless terminal to the base station node.

Combating DRX Deadlock: Reactive Modes: Detecting Missing PUSCH

There are other ways to detect the DRX deadlocks. Another unsynchronization determination technique comprises determining that the base station node is unsynchronized with the current discontinuous reception (DRX) state of the wireless terminal by determining lack of reception on a Physical Uplink Shared Channel (PUSCH) from the wireless terminal after the base station node has scheduled an uplink transmission from the wireless terminal.

As background for this “missing PUSCH” DRX deadlock detection technique, recall that the 3GPP standard mandates that the wireless terminal detect and decode any grant for UL-SCH transmission that occurs during the on-duration phase; at detection of a new UL transmission start its drx-InactivityTimer; and, remain active while drx-Inactivity Timer is running Therefore, the base station node 28 can use any lasting lack of received PUSCH transmission as a good indication of a DRX deadlock, e.g., in case of a continuous detection of DTX on PUSCH the base station node 28 can suspect that wireless terminal 30 did not detect a grant for UL-SCH transmission during the on-duration phase and that the wireless terminal 30 likely resides in a phase where it again has disrupted its reception.

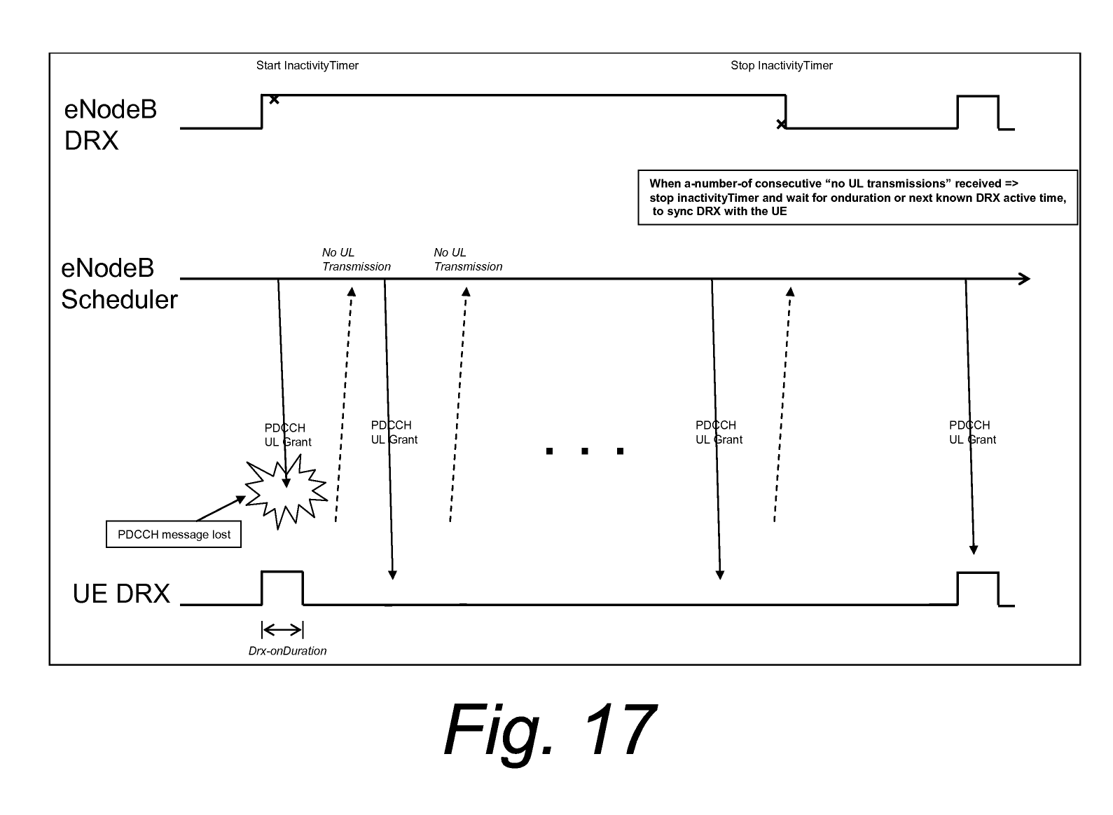

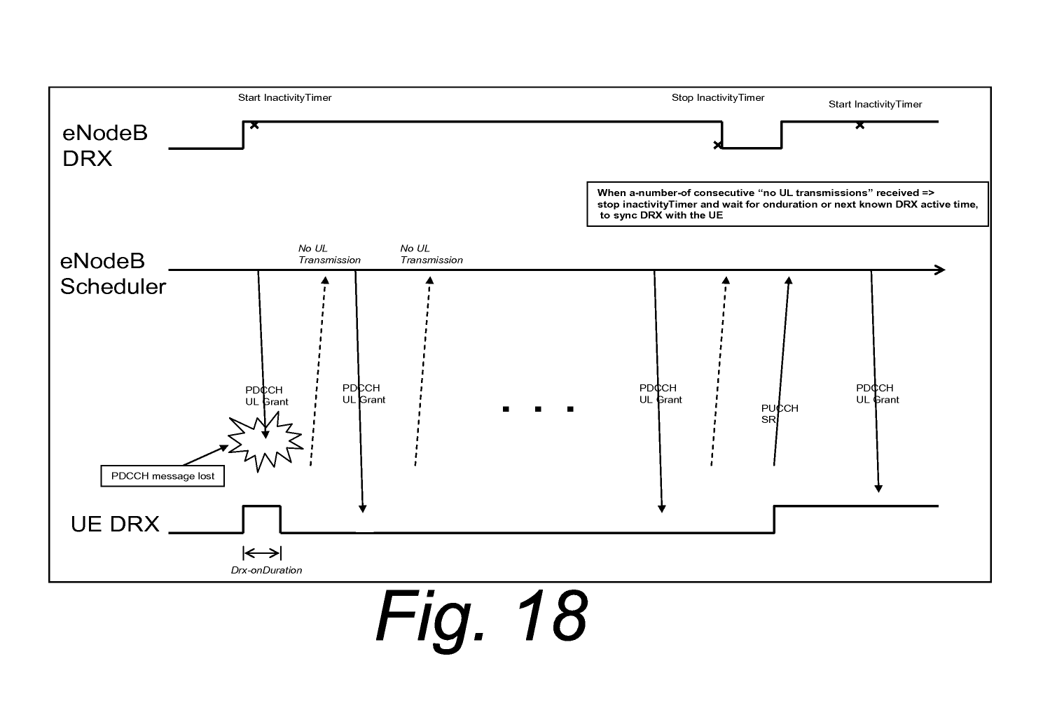

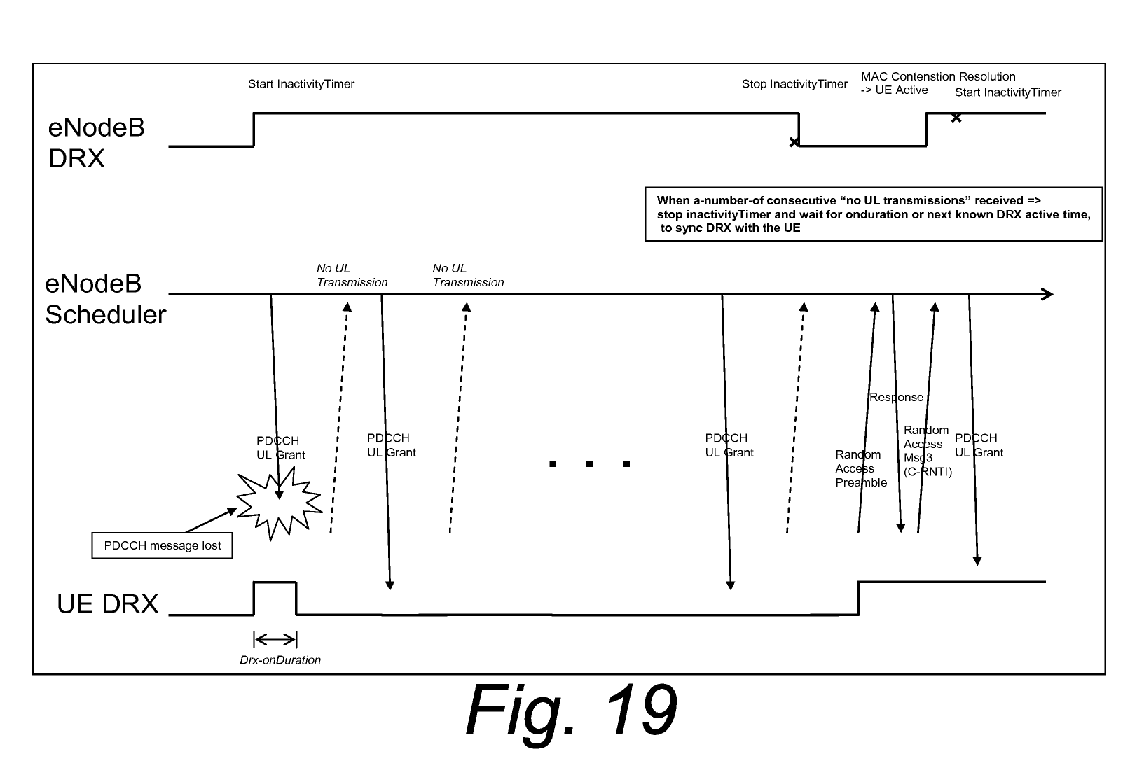

In the above regard, FIG. 17 illustrates a decision process to handle such a situation of a missing PUSCH. When base station node 28 has scheduled the wireless terminal 30 on the uplink (UL) the base station node 28 can use the lack of PUSCH reception to decide if the wireless terminal 30 is in its DRX inactive time or not. When the base station node 28 has scheduled wireless terminal 30 and has not received any PUSCH receptions for a configured value of max-granting-without-PUSCH-data, it stops scheduling this wireless terminal 30 since the wireless terminal 30 is likely not in a receptive phase. The base station node 28 stops the internal running drx-inactivityTimer. Further, the base station node 28 postpones any further grants for UL-SCH transmission, and any ongoing transmission in DL. The wireless terminal 30 then waits for the next possibility to resynchronize DRX, e.g., to the next common phase or indication of DRX active time. FIG. 17 illustrates DRX resync to the next commonly known on-duration phase. The next known DRX active time can also be detected by indication of new PUSCH transmission as illustrated by FIG. 18, or a new random access attempt from the UE as illustrated as FIG. 19. The wireless terminal 30 will starts mac-ContentionResolutionTimer once Msg3 with C-RNTI is transmitted as described by section 5.1.5 of 3GPP TS 36.321, version 10.4.0. The wireless terminal 30 will remain DRX active as long as timer is running according to section 5.7 of 3GPP TS 36.321, version 10.4.0.

In general, DRX cycling is based on SFN modulo, see chapter 5.7 in 3GPP TS 36.321. The Long DRX cycles are multiples of the Short DRX cycles (i.e. all on-durations of Long DRX cycling co-incides with on-durations of Short DRX cycles (the previous are fewer). The on-duration occurrences are aligned to the start of DRX (see drxStartOffset in 3GPP TS 36.321 and in 3GPP TS 36.331). Other ‘commonly knowns’ are the occurrence of SR, scheduling request (see 5.4.4 in 3GPP TS 36.321), the wireless terminal 30 transmits it (re-occurring as long as SR is pending. i.e. until wireless terminal is granted). Based on prior knowledge of SR periodicity and SR false detection probablities, the eNB will know when the wireless terminal has transmitted SR. Chapter 5.7 in 3GPP TS 36.321 defines SR pending as part of active time, thus this too is commonly known. Then another part of the aggregate of active time phases is the occurences where UE concludes ‘an UL grant might occur for a pending HARQ retransmission’ (see 5.7 in 3GPP TS 36.321). The wireless terminal must re-occurringly wake up from DRX at each possible TTI where a grant for a HARQ retransmission might occur. The only thing that will allow UE to flush the HARQ buffer and consider the HARQ transmission s finalized is 1) maximum number of retransmissions reached; 2) the wireless terminal goes out of synch and 3) The UE concludes that PDCCH indicates a new transmission (DL or UL). This last part of the aggregate can also be used as another ‘commonly knowns’, as long as eNB have enough evidence to support the idea that the wireless terminal actually started the HARQ transmission.

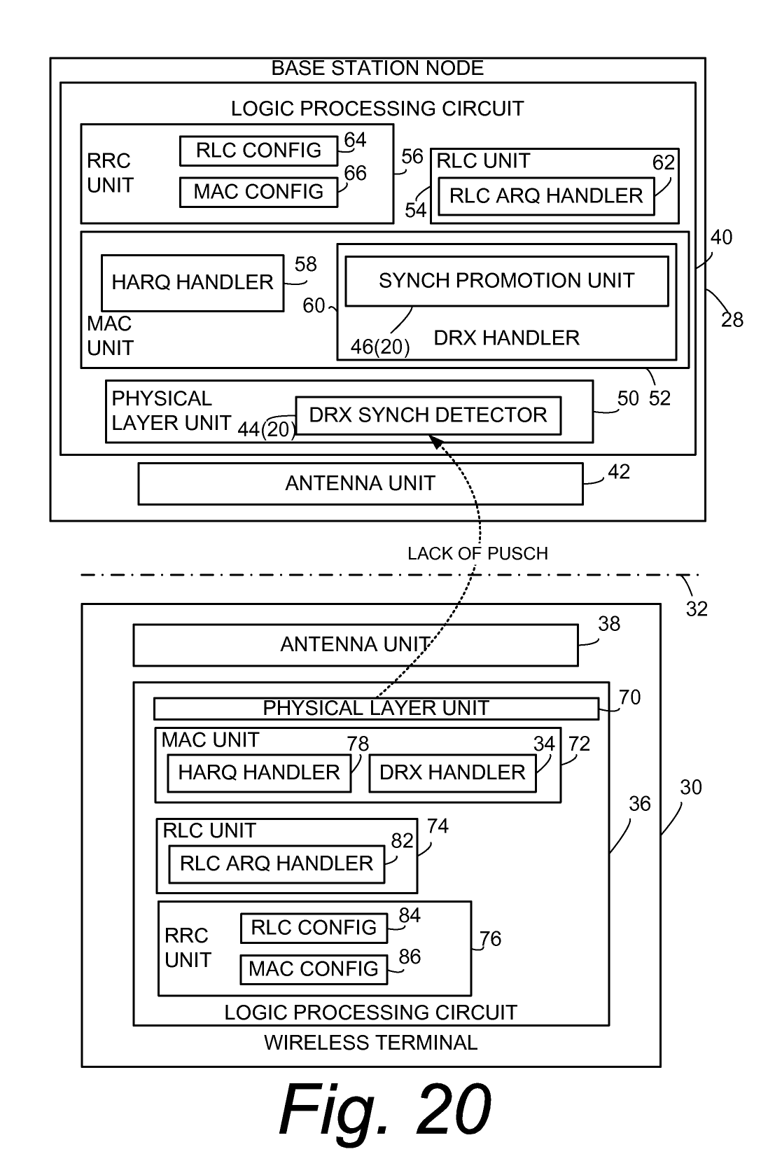

FIG. 20 shows a non-limiting example implementation of base station node 28 and wireless terminal 30 arranged for using the reactive mode which employs the “missing PUSCH” DRX deadlock detection technique. In the FIG. 20 reaction mode embodiment physical layer unit 50 hosts DRX synch detector 44(20) and DRX handler 60 hosts sync promotion unit 46(20).

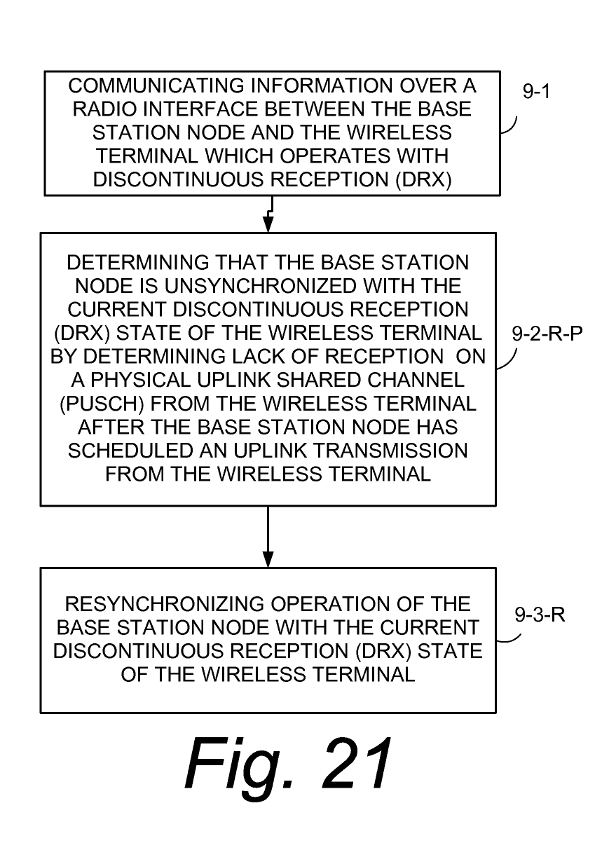

FIG. 16 illustrates example acts or steps included in a method of operating a base station node which employs the “missing PUSCH” DRX deadlock detection technique. Acts 9-1 and 9-3-R of FIG. 21 are the same as those of FIG. 9. Act 9-2-R-P of FIG. 21, which follows act 9-1, comprises determining that the base station node is unsynchronized with the current discontinuous reception (DRX) state of the wireless terminal by determining lack of a transmission (and, thus, lack of reception) on a Physical Uplink Shared Channel (PUSCH) from the wireless terminal after the base station node has scheduled an uplink transmission from the wireless terminal. FIG. 20 further shows by a dotted line the missing PUSCH signal which otherwise would have emanated from physical layer unit 70 of wireless terminal 30.

Combating DRX Deadlock: Reactive Modes: Other Detecting Techniques

There are also variants of the above solutions with additional potential to speed up the detection of a DRX deadlock. For example, in another example embodiment the above-mentioned absence of HARQ feedback (as response to DL-SCH transmission) can be combined with the above-mentioned absence of PUSCH transmission (as response to grant for UL-SCH transmission) as an aggregated more certifying indicator of a DRX deadlock.

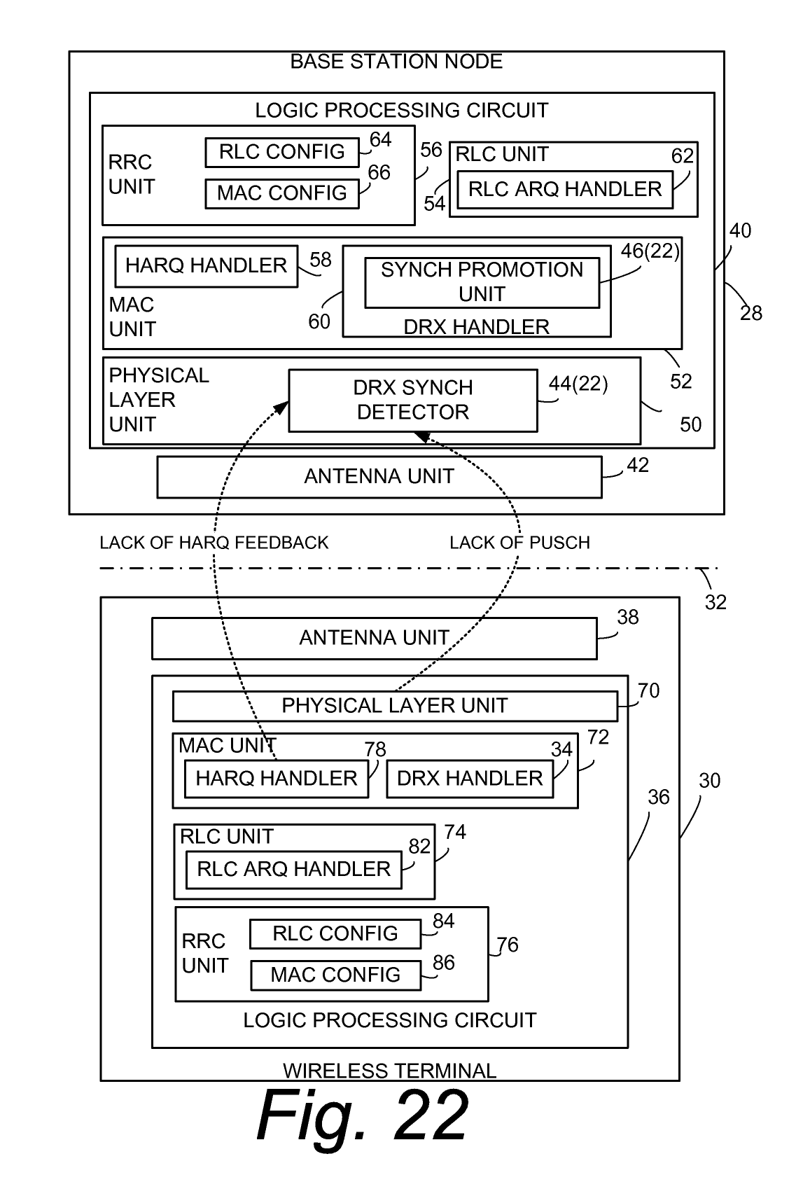

Thus, another unsynchronization determination technique is a combination of the “missing HARQ” and “missing PUSCH” techniques. FIG. 22 shows a non-limiting example implementation of base station node 28 and wireless terminal 30 arranged for using the reactive mode which employs the combination DRX deadlock detection technique. In the FIG. 22 reaction mode embodiment physical layer unit 50 hosts DRX synch detector 44(22) and DRX handler 60 hosts sync promotion unit 46(22).

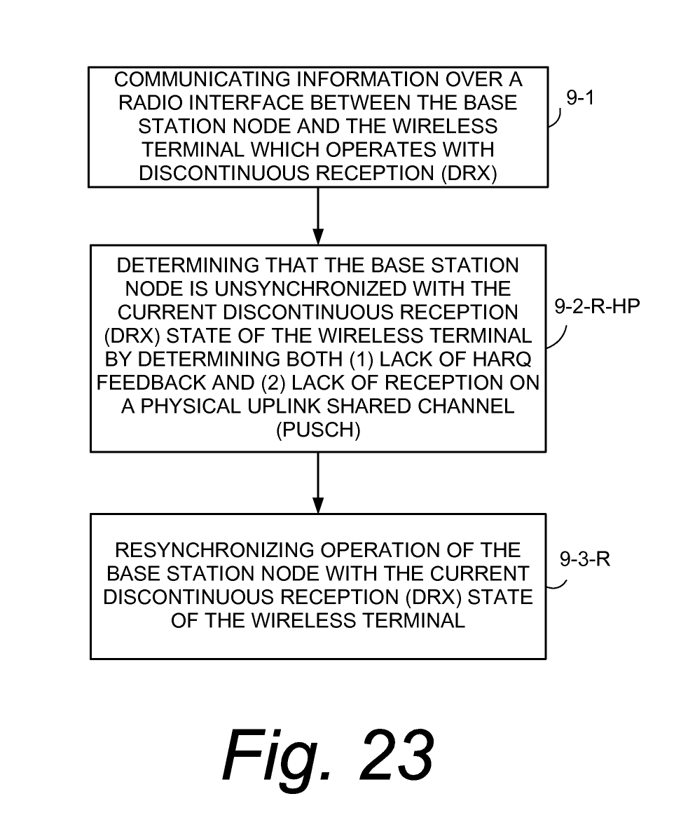

FIG. 23 illustrates example acts or steps included in a method of operating a base station node which employs the “missing PUSCH” DRX deadlock detection technique. Acts 9-1 and 9-3-R of FIG. 23 are the same as those of FIG. 9. Act 9-2-R-HP of FIG. 23, which follows act 9-1, comprises determining that the base station node is unsynchronized with the current discontinuous reception (DRX) state of the wireless terminal by determining both (1) lack of HARQ feedback on a Physical Uplink Control Channel (PUCCH) from the wireless terminal after the base station node has scheduled a downlink transmission to the wireless terminal, and (2) lack of reception on a Physical Uplink Shared Channel (PUSCH) from the wireless terminal after the base station node has scheduled an uplink transmission from the wireless terminal. FIG. 22 further shows by a first dotted line the missing HARQ feedback, which would otherwise have emanated from HARQ handler 78 of wireless terminal 30 and by a second dotted line the missing PUSCH signal which otherwise would have emanated from physical layer unit 70 of wireless terminal 30.

Combating DRX Deadlock: Reactive Modes: Confirming Techniques

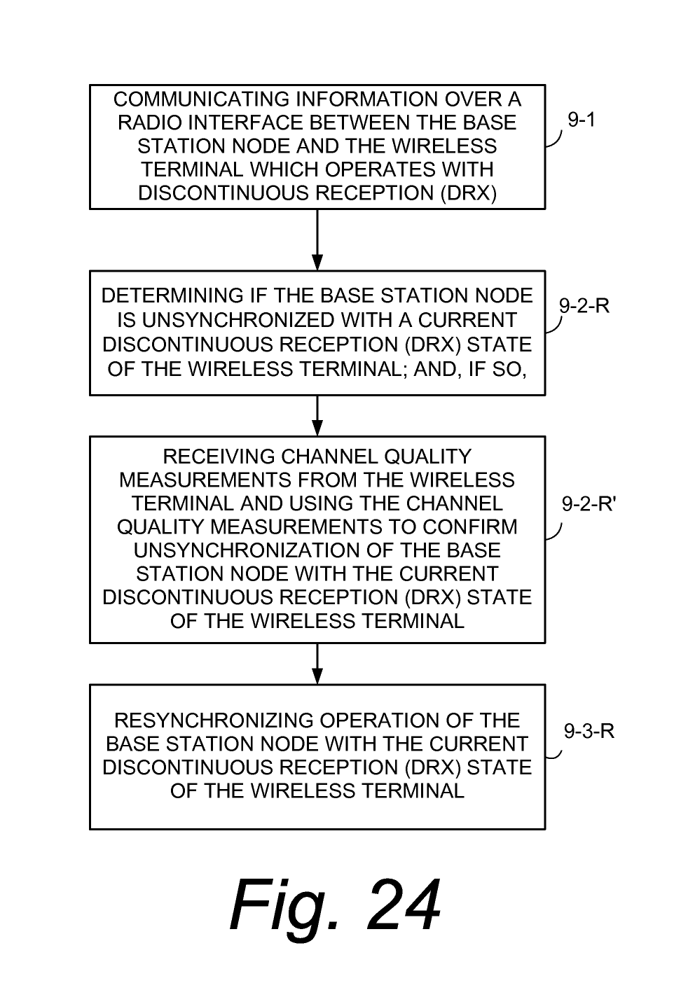

Regardless of what determination technique is employed, in an optional further embodiment illustrated by way of example in FIG. 24, channel quality measurements may be used to confirm unsynchronization of the base station node with the current discontinuous reception (DRX) state of the wireless terminal. Acts 9-1, 9-2-R, and 9-3-R of FIG. 24 are the same as those of FIG. 9. FIG. 24 differs from the general method of FIG. 9 by inclusion of act 9-2-R′ which follows act 9-2-R. Act 9-2-R′ comprises receiving channel quality measurements from the wireless terminal and using the channel quality measurements to confirm unsynchronization of the base station node with the current discontinuous reception (DRX) state of the wireless terminal. The concurrent reception and gathering of wireless terminal measurements confirming bad DL quality will further certify any detection of a DRX deadlock, e.g., the reception of CQI feedback will make the above triggers to resynchronize DRX an even more certifying indicator: the CQI include a measure of quality of the DL radio channel.

Combating DRX Deadlock: Proactive Modes

Another mode, which can be used as an alternative or precursor to the reactive mode, is the proactive mode. The proactive mode includes various preventive solutions to avoid that DRX deadlocks occur. The basic concept of the proactive mode is to monitor DL coverage levels in the system and take actions in due time before DL coverage problems will cause DRX deadlocks to occur.

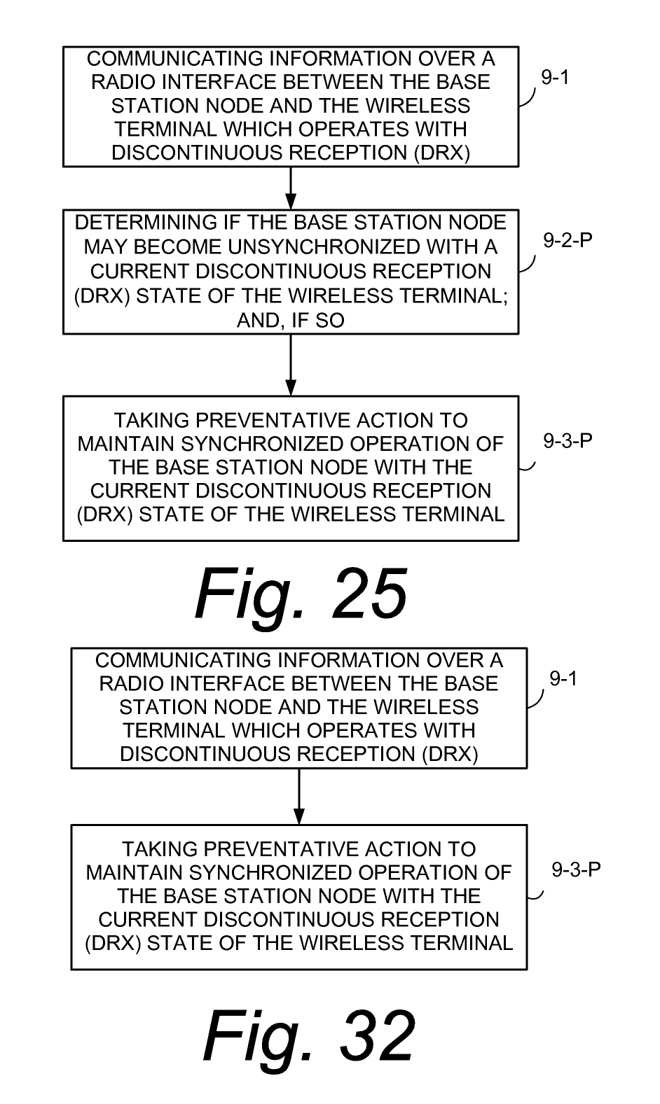

FIG. 25 illustrates example, representative acts or steps included in the proactive mode. The basic acts or steps of FIG. 25 resemble those of FIG. 9 except that the act 9-2-P and act 9-3-P implement only the second alternative subacts of 9-2 and act 9-3, respectively. Specifically, act 9-2-P comprises determining if the base station node may become unsynchronized with a current discontinuous reception (DRX) state of the wireless terminal. If the determination of act 9-2-P is affirmative, act 9-3-P is performed. Act 9-3-P comprises taking preventative action to maintain synchronized operation of the base station node with the current discontinuous reception (DRX) state of the wireless terminal.

Combating DRX Deadlock: Proactive Modes: Preventative Actions

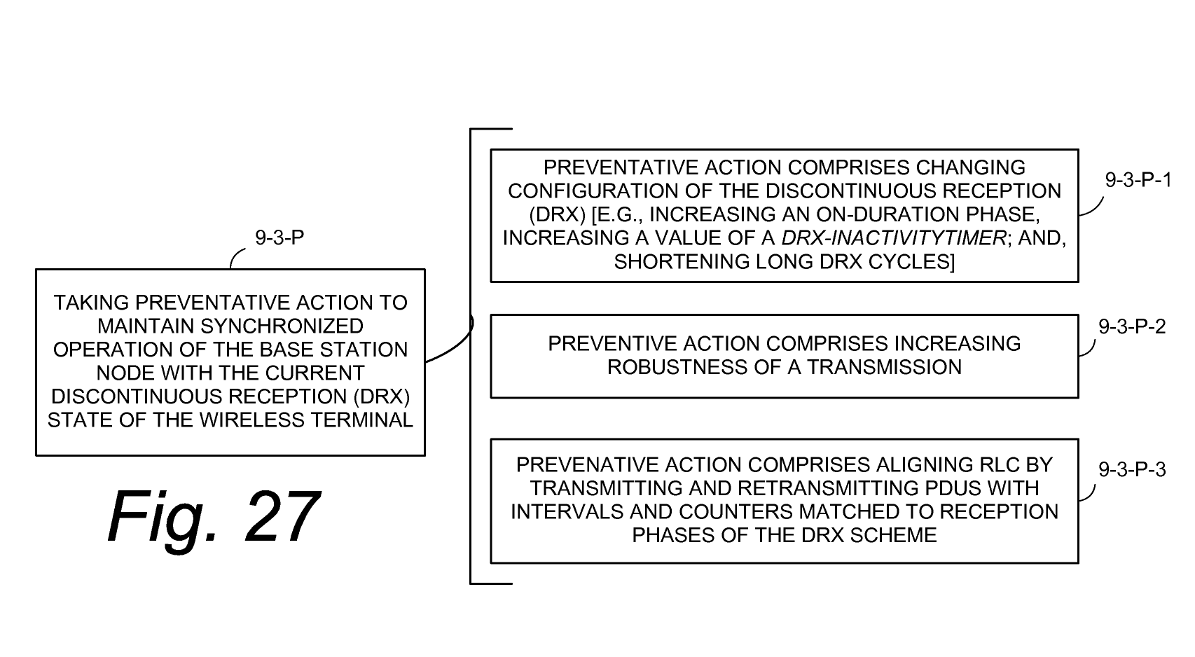

As reflected by act 9-3-P, the proactive mode includes one or more ways of taking preventative action to maintain synchronized operation of the base station node with the current discontinuous reception (DRX) state of the wireless terminal Example such preventative actions are illustrated in FIG. 27.

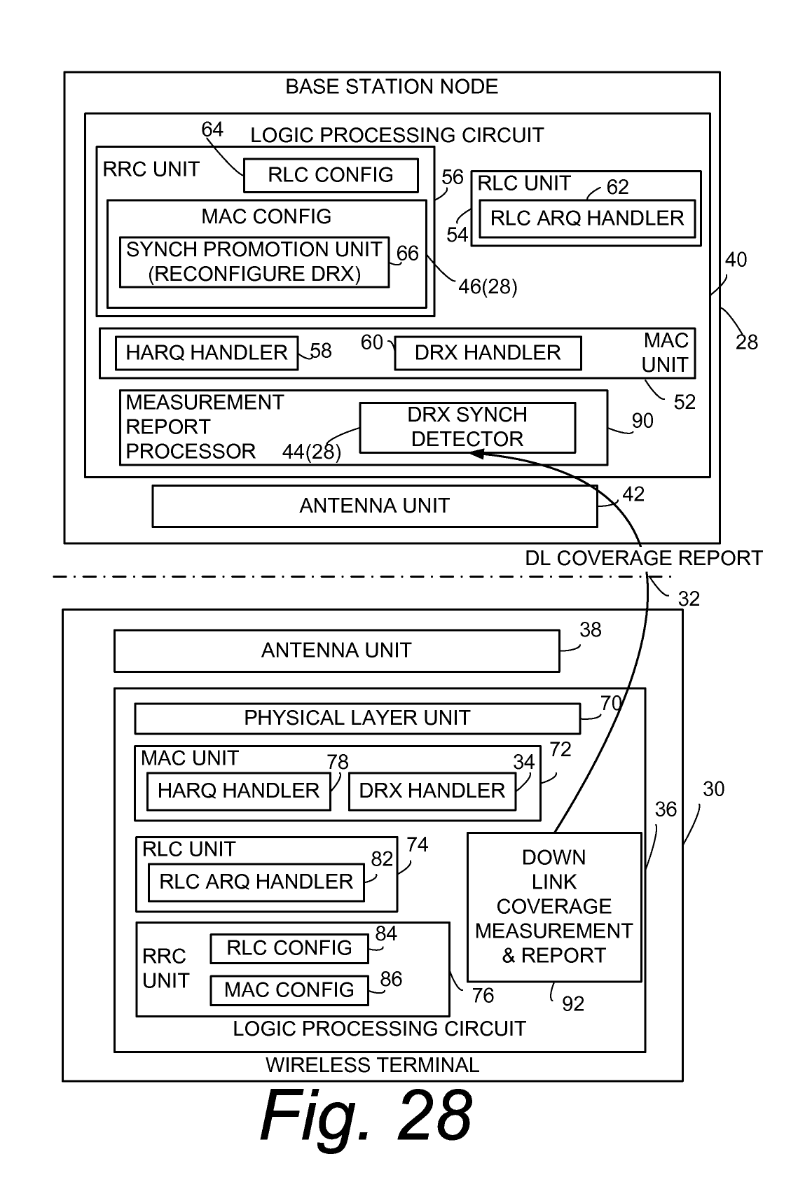

In one example embodiment the preventive action comprises changing configuration of the discontinuous reception (DRX), as depicted by act 9-3-P-1. An example base station node 28 and wireless terminal 30 suitable for such example embodiment is illustrated in FIG. 28. In the example embodiment of FIG. 28, DRX synch detector 44(28) is hosted by or located in measurement report processor 90 and sync promotion unit 46(28) is hosted by or located in MAC configuration unit 66 of radio resource control (RRC) unit 56. In an example implementation of such embodiment changing configuration of the discontinuous reception (DRX) may involve at least one of increasing an on-duration phase, increasing a value of a drx-InactivityTimer; and, shortening Long DRX cycles. FIG. 28 further shows that wireless terminal 30 includes downlink coverage measurement and report unit 92 which is configured, e.g., to provide a downlink coverage report which includes, e.g., the indication of downlink (DL) coverage as mentioned above. Thus, downlink coverage measurement and report unit 92 serves to monitor and provide the coverage level on the downlink (DL) in terms of, for example, at least one of received signal received power (RSRP), received signal received quality (RSRQ), and channel quality index (CQI).

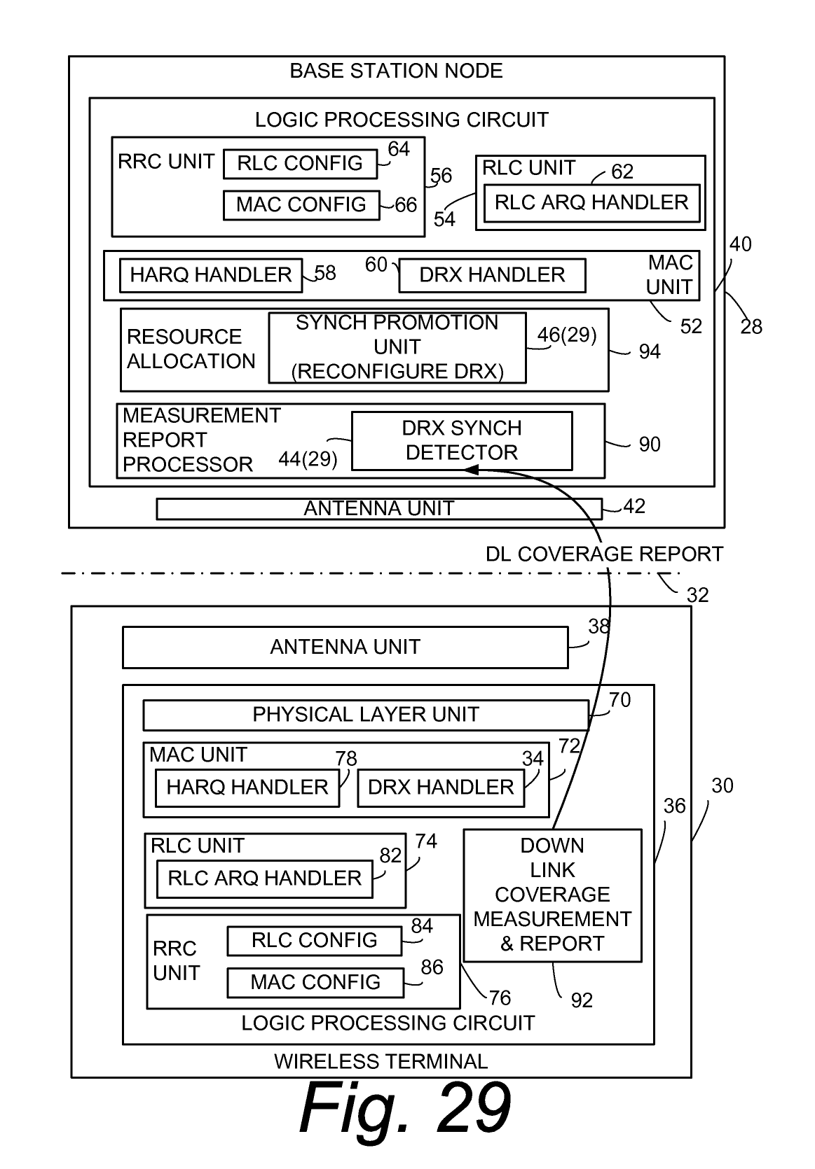

In another example embodiment the preventive action comprises increasing robustness (e.g., energy) of at least a first transmission, i.e., of a HARQ transmission which contains an initial DL assignment, as depicted by act 9-3-P-2 of FIG. 27. By “first” transmission is meant a transmission that holds initial DL assignment of ‘new data’, which is involved for determining the phases of DRX. 3GPP TS 36.321, version 10.4.0, chapter 5, clause 5.7, states, in this regard, that if the PDCCH indicates a new transmission (DL or UL), the drx-InactivityTimer is to be started or re-started. In an example embodiment, the increased robustness prompted by act 9-3-P-2 may be limited to the first transmission, but may extend to other transmissions as well. An example base station node 28 and wireless terminal 30 suitable for such example embodiment is illustrated in FIG. 29. In the example embodiment of FIG. 29, DRX synch detector 44(29) is hosted by or located in measurement report processor 90 and sync promotion unit 46(28) is hosted by or located in resource allocation unit 94 of base station node 28. The resource allocation unit 94 may be realized by or comprise logic processing circuit 40.

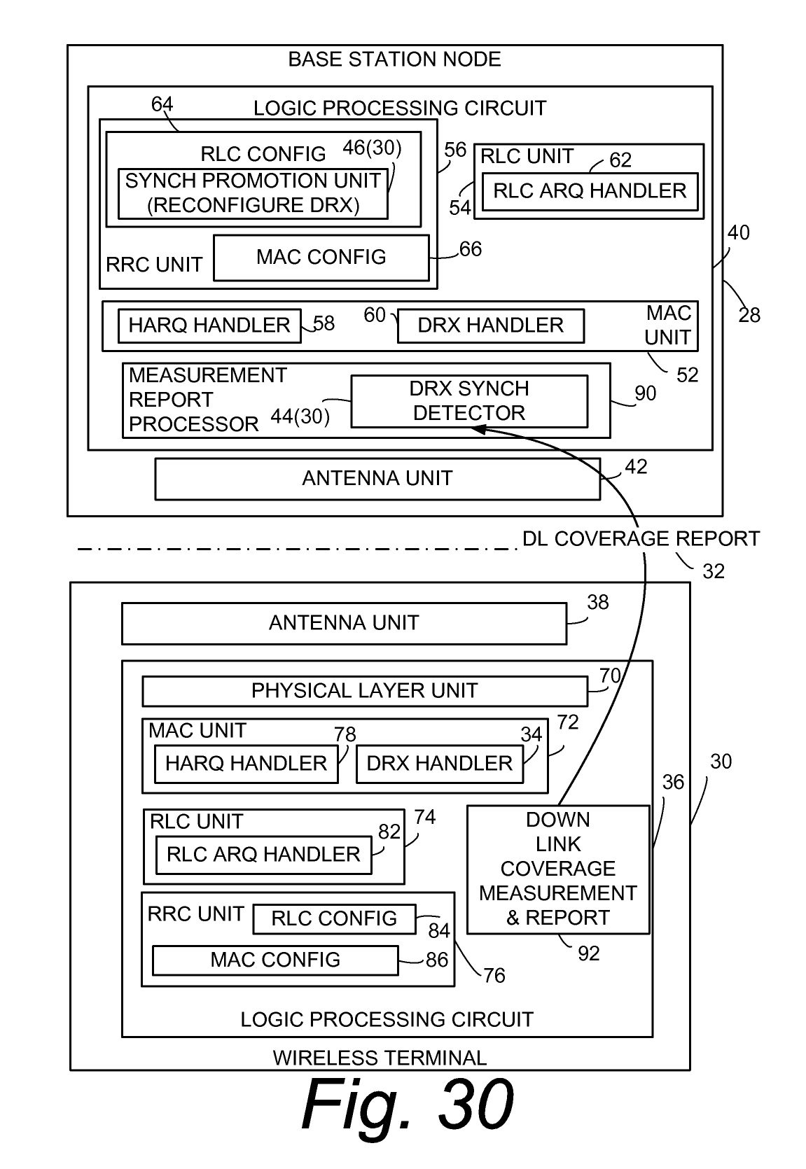

In yet another example embodiment the preventive action comprises aligning the radio link control (RLC) operations by transmitting and retransmitting PDUs with intervals and counters matched to reception phases of the DRX scheme, as depicted by act 9-3-P-3 of FIG. 27. An example base station node 28 and wireless terminal 30 suitable for such example embodiment is illustrated in FIG. 30. In the example embodiment of FIG. 30, DRX synch detector 44(29) is hosted by or located in measurement report processor 90 and sync promotion unit 46(28) is hosted by or located in RLC configuration unit 64 of radio resource control (RRC) unit 56 of base station node 28.

Thus, an alternative preventative action is to have RLC transmit and retransmit PDUs with intervals and counters that are well matched to the reception phases of the DRX scheme. Respecting act 9-3-P-3 and the RLC realignment, the time intervals at hand for RLC retransmission is ruled by the IE “RLC-Config” in 3GPP TS 36.331 clause 6.3.2:

t-PollRetransmit = [ . . .
ms40,ms45,ms50,ms55,ms60,ms65,
ms70,ms75,ms80, ms85,ms90,ms95,
ms100, . . . ].

There is one RLC-config per radio bearer, so plural in intervals. The time intervals at hand for RLC retransmission is ruled by the IE “RLC-Config” in 36.331 clause 6.3.2:
maxRetxThreshold=[t1, t2, t3, t4, t6, t8, t16, t32].
There is one RLC-config per radio bearer, so plural in counters. The reception phases of DRX will be determined by the IE “DRX-Config” in 36.331 clause 6.3.2:
shortDRX—Cycle=[ . . . sf20,sf32,sf40,sf64 . . . ];
drxShortCycleTimer=[1.16]; longDRX—Cycle=[sf10,sf20, . . . sf80, sf128,sf160,sf256,sf320, . . . ]

### There is one DRX-config per UE.

Thus, in the proactive mode there are various ways of performing the preventative action, e.g., plural solutions: one solution where certain PDCCH transmission characteristics are used; another solution where the mode or parameters of DRX are reconfigured at the cell or handover border; and, a third solution where the cyclic RLC retransmission is aligned (matched) to the cyclic occurrences of DRX on-duration phases, e.g., by a configuration (if done without measurements) or reconfiguration (measurement based) of RLC, DRX (in MAC) or both.

Combating DRX Deadlock: Proactive Modes: Coverage Level

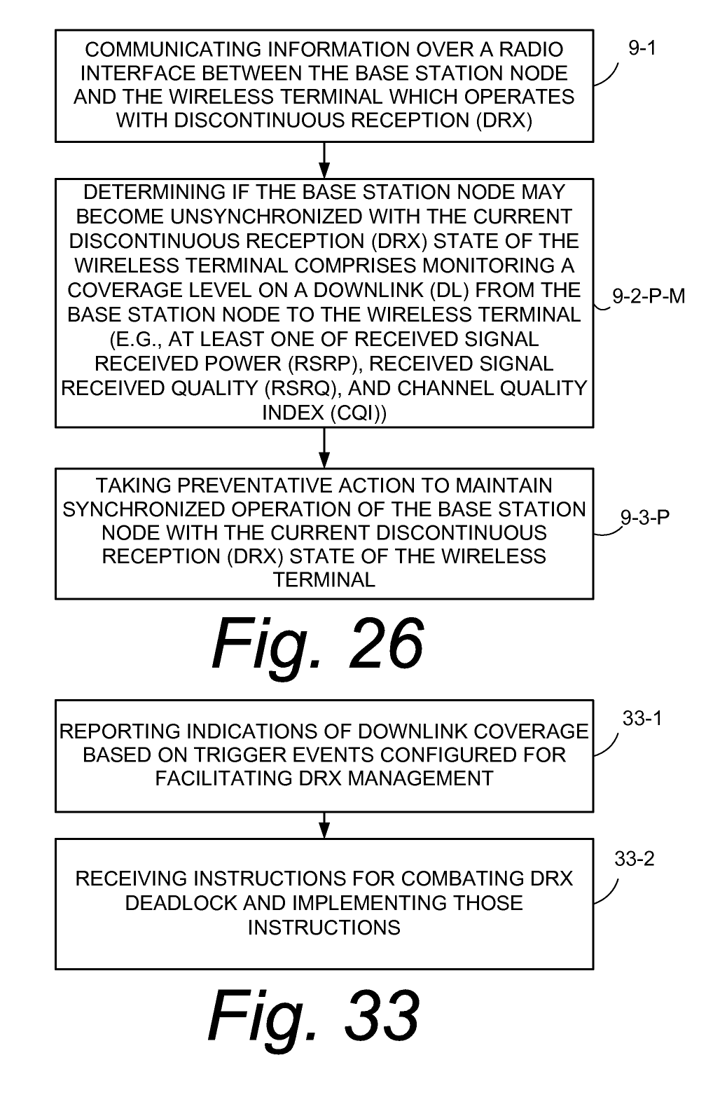

In an example implementation of the proactive mode, determining if the base station node may become unsynchronized with the current discontinuous reception (DRX) state of the wireless terminal comprises monitoring a coverage level on a downlink (DL) from the base station node to the wireless terminal. FIG. 26 illustrates example acts or steps in such an implementation, with acts 9-1 and 9-3-P of FIG. 26 being the same as those of FIG. 25. Act 9-2-P-M of FIG. 26, which follows act 9-2, comprises determining if the base station node may become unsynchronized with the current discontinuous reception (DRX) state of the wireless terminal comprises monitoring a coverage level on a downlink (DL) from the base station node to the wireless terminal. In an example implementation, monitoring the coverage level on the downlink (DL) comprises monitoring at least one of received signal received power (RSRP), received signal received quality (RSRQ), and channel quality index (CQI).

In the example embodiments of FIG. 28, FIG. 29, and FIG. 30 it was mentioned that the DRX synch detectors are hosted by or located in measurement report processor 90. It should be noted that in the proactive mode the DRX synch detectors are not necessarily detecting lack of actual synchronization, but detect potential loss of synchronization, e.g., potential DRX deadlock situations (e.g., before DRX deadlock actually occurs). In example embodiments such “detection” as performed by the DRX synch detectors may comprise a monitoring of coverage level on the downlink (DL). As explained above, this monitoring of coverage level may comprise monitoring at least one of received signal received power (RSRP), received signal received quality (RSRQ), and channel quality index (CQI). In view of the fact that different types of coverage indicators may be used, FIG. 28, FIG. 29, and FIG. 30 illustrate the respective DRX synch detectors as being situation in measurement report processor 90 for the sake of being generic to all types of indicators. However, it will be appreciated by the person skilled in the art that, depending on the type of coverage indicator utilized, the DRX synch detector may be illustrated more precisely for respective differing implementations.

In the above regard, in some example implementations the coverage indicator may be channel quality index (CQI), as mentioned above. CQI is exchanged between the physical layer unit of the wireless terminal 30 and the physical layer unit of base station node 28. On the other hand, the aforementioned RSRQ and RSRP values are initially manufactured in the layer 1 physical layer unit of wireless terminal 30; then filtered by the layer 3 radio resource control (RRC) unit 76 in wireless terminal 30; and then sent to the corresponding RRC peer (radio resource control (RRC) unit 56) in base station node 28.

Methods for monitoring DL coverage levels are plentiful in both literature and prior art. A common scheme used for MAHO mobility control is to configure the wireless terminal 30 to monitor and report DL coverage attributes (e.g. RSRP and RSRQ, as described in 3GPP TS 36.331, Evolved Universal Terrestrial Radio Access (E-UTRA); Radio Resource Control (RRC); Protocol specification, Version 10.4.0. The reporting described in 3GPP TS 36.331 is event-triggered and the set of events include the following:
Event A2 (Serving becomes worse than threshold),
Event A1 (Serving becomes better than threshold)

Thus, in an example implementation a wireless terminal 30 may be configured to start event-triggered reporting at two different thresholds A2, where A2₁>A2₂. As long as no event A2 has been triggered, the wireless terminal 30 is controlled to use a DRX configuration with, e.g., a good battery saving potential, for example. Then later, when the DL coverage level falls below A2₁, a preventative action is implemented. For example, as reflected by act 9-3-P-2 of FIG. 27, the battery saving potential may reduced as the base station node 28 opts for a more robust configuration, e.g., boosting the energy of the first transmission. Additionally or alternatively, as act 9-3-P-1 the base station node 28 may implement the preventative action of a more durable DRX configuration with longer on-duration phase, longer drx-Inactivity Timer and shorter Long DRX cycles. When the next A2₂ is passed, thus both A2 have been passed, DRX can be turned off when the lower of the A2₂ are passed. Two different thresholds A1, where A1₁<A1₂ can be used for the reverse case when DL coverage improve.

Another example scenario is to monitor the received CQI sent from the wireless terminal and have similarly defined thresholds that will trigger a change of DRX configuration or even turn off DRX when the wireless terminal is close to a cell border. An example of this method would be to have a DRX configuration with good battery saving potential when CQI is high, e.g., in the range 15-10. When CQI drops, e.g., to levels in the range 10-5, the battery saving potential is reduced as the base station node 28 opts for a more robust configuration, e.g., boosting the energy of the first transmission and/or with a more durable DRX configuration with longer on-duration phase, longer drx-InactivityTimer and shorter Long DRX cycles. When CQI drops below 5, DRX can be turned off to avoid dropping the wireless terminal 30. The opposite handling is used for the reverse case when the DL coverage improves.

Combating DRX Deadlock: Combining Proactive and Reactive Modes

The technology disclosed herein also encompasses embodiments in which if, despite preventative action, the base station node becomes unsynchronized with the current discontinuous reception (DRX) state of the wireless terminal; the base station node 28 goes on to resynchronizing operation of the base station node with the current discontinuous reception (DRX) state of the wireless terminal. For example, the technology disclosed herein includes methods to re-synchronize using points of DRX active time that are common and known to both sides, before further attempts to transmit occurs.

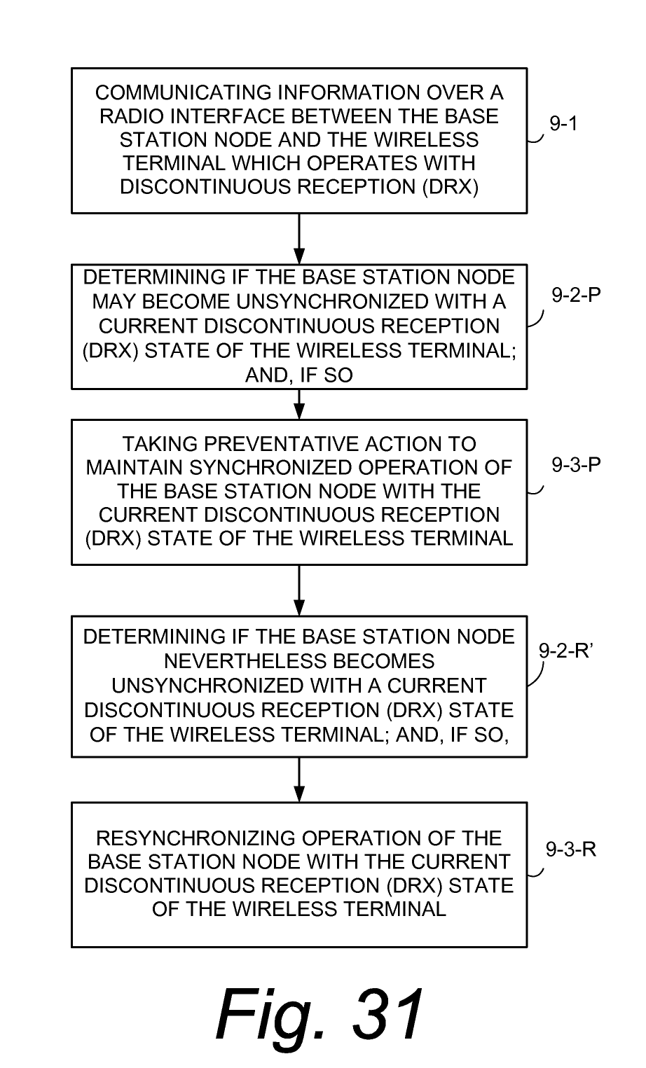

FIG. 31 illustrates example acts or steps that may be included in an example embodiment which combines features of the proactive and reactive modes. The basic acts or steps of FIG. 31 include those of FIG. 25 and two further acts of FIG. 10. In particular, act 9-2-R′ and act 9-3-R follow act 9-3-P. Act 9-2-R′ comprises determining if the base station node, despite the preventative act 9-3-P, becomes unsynchronized with a current discontinuous reception (DRX) state of the wireless terminal. If so, act 9-3-R is performed. Act 9-3-R comprises resynchronizing operation of the base station node with the current discontinuous reception (DRX) state of the wireless terminal.

For the embodiment and mode of FIG. 31, any of the foregoing embodiments and modes of the reactive mode or the proactive mode may be utilized for performing the acts of FIG. 31, and other auxiliary or optional acts may also be included.

Combating DRX Deadlock: Proactive Modes: Automatic Prevention

FIG. 32 illustrates a method that may be practice by base station node 28 without having to make detection or receive explicit signal input from wireless terminal 30. The method of FIG. 32 is similar to that of FIG. 25, but omits an act (such as act 9-2-P) which requires a special measurement-dependent determination or signal from wireless terminal 30. In the FIG. 32 embodiment the base station node 28 may automatically take one or more of preventative actions such as increasing robustness of a transmission or aligning RLC and DRX to have RLC transmit and retransmit PDUs with intervals and counters matched to reception phases of the DRX scheme (see FIG. 27).

Combating DRX Deadlock: Wireless Terminal Operational Method

FIG. 33 shows example, basic acts or steps involved in an example mode of operating a wireless terminal according to an example embodiment. As mentioned above, in at least some example embodiments the wireless terminal 30 reports measurements or indications of downlink (DL) coverage. For example, it was described above with reference to FIG. 28-FIG. 30 that the wireless terminal may report coverage level on the downlink (DL) comprises in terms of at least one of received signal received power (RSRP), received signal received quality (RSRQ), and channel quality index (CQI), and that such measurements or coverage indications may be reported when triggered by certain events or triggers, such as Events A2₁, A2₂ (where A2₁>A2₂) and Events A1₁, A1₂ (where A1₁<A1₂), e.g., a refined event/triggering reporting which can be used for DRX management. In this regard, act 33-1 comprises the wireless terminal 30 reporting indications of downlink coverage based on trigger events configured for facilitating DRX management. It is not only the trigger but each instance of an event, e.g., event A1-1, that is associated to a specific measurement. The measurement is separately configured by a signal over RRC from base station node 28 to the wireless terminal 30. The measurement will have a unique id which will be used by wireless terminal 30 when it reports to the base station node 28.

Act 33-2 comprises the wireless terminal 30 receiving, as a result of the indication(s) reported at act 33-1, a communication from base station node 28 with instructions for combating DRX deadlock and implementing those instructions. The instructions of act 33-2 may be instructions to configure or adapt the wireless terminal 30 to implement any one or more of the preventative actions depicted in FIG. 27, e.g.: changing configuration of the discontinuous reception (DRX) [as depicted by act 9-3-P-1]; increasing robustness (e.g., energy) of at least a first transmission, i.e., of a HARQ transmission which contains an initial DL assignment [as depicted by act 9-3-P-2]; and/or aligning the radio link control (RLC) operations by transmitting and retransmitting PDUs with intervals and counters matched to reception phases of the DRX scheme [as depicted by act 9-3-P-3]. The instructions for configuring or adapting the wireless terminal 30 to implement any one or more of the preventative actions may be borne, for example, by a RrcConnectionReconfiguration message and information element drx-config in 3GPP TS 36.331.

Example Advantages

The advantages of the technology disclosed herein include but are not limited to conservation of radio resources and less service interruption by reducing the amount of void transmissions that occurs while UE is not in a receptive state.

The reactive approach provides a reliable scheme which does not take action unless it is really needed. By stop scheduling the DL of a wireless terminal suspected of DRX inconsistency, unnecessary re-transmissions are avoided which save PDCCH and PDSCH resources. These resources can instead be used to communicate with another wireless terminal. This behavior has a positive impact on the aggregated throughput in the cell. By allowing the eNodeB to re-sync with a known DRX active time, unnecessary RLC delivery failures are avoided and thereby RAB releases or UE releases are also avoided. By using the CQI reports sent by the UE on PUCCH together with the HARQ feedback, the eNodeB can make a more reliable detection of DRX inconsistency between the UE and the eNodeB.

The proactive approach calls for action before the situation occurs. The technology disclosed herein provides methods that acknowledge the fact that DRX itself—when creating opportunities for discontinuous reception—creates fewer opportunities for transmission, thereby in some sense increases the need for good DL coverage. The technology disclosed herein includes methods to monitor the DL coverage levels and reconfigure to more robust DRX settings or other transmission schemes as coverage decreases.

### ABBREVIATIONS

AM Acknowledged Mode
ARQ Automatic Repeat request
CQI Channel Quality Identifier
DL DownLink
DRX Discontinuous Reception
eNB enhanced NodeB
e-RAB enhanced Radio Access Bearer
HARQ Hybrid ARQ
MAC Medium Access Control
MAHO Mobile Assisted Handover
PDU Protocol Data Unit
QCI QoS Class Indicator
QoS Quality of Service
RLF Radio Link Failure
RLC Radio Link Control
RRC Radio Resource Control
RSRP Reference Signal Received Power
RSRQ Reference Signal Received Quality
SDU Service Data Unit
TCP Transmission Control Protocol
UE User Equipment
UL UpLink
UM Unacknowledged Mode.

### REFERENCES

The following references (all of which are incorporated herein in their entirety) may be illuminate or relate to topics discussed herein:
3GPP TS 36.321, Evolved Universal Terrestrial Radio Access (E-UTRA); Medium Access Control (MAC) protocol specification, Medium Access Control (MAC) protocol specification, version 10.4.0.
3GPP TS 36.322, Evolved Universal Terrestrial Radio Access (E-UTRA); Radio Link Control (RLC) protocol specification, Radio Link Control (RLC) protocol specification, version 10.0.0.
3GPP TS 36.300, Evolved Universal Terrestrial Radio Access (E-UTRA) and Evolved Universal Terrestrial Radio Access Network (E-UTRAN); Overall description; Stage 2, version 10.6.0.
3GPP TS 36.331, Evolved Universal Terrestrial Radio Access (E-UTRA); Radio Resource Control (RRC); Protocol specification, Version 10.4.0.

In example embodiments and as depicted by way of logic processing circuit 36 and logic processing circuit 40, various functionalities and units described herein may be realized by a machine platform. The terminology “machine platform” is a way of describing how the functional units of node 28 or wireless terminal 30 can be implemented or realized by machine. The machine platform can take any of several forms, such as (for example) electronic circuitry in the form of a computer implementation platform or a hardware circuit platform. A computer implementation of the machine platform may be realized by or implemented as one or more computer processors or controllers as those terms are herein expansively defined, and which may execute instructions stored on non-transient computer-readable storage media. In such a computer implementation the machine platform may comprise, in addition to a processor(s), a memory section (which in turn can comprise random access memory; read only memory; an application memory (a non-transitory computer readable medium which stores, e.g., coded non instructions which can be executed by the processor to perform acts described herein); and any other memory such as cache memory, for example). Another example platform suitable for transmission mode selector 40 is that of a hardware circuit, e.g., an application specific integrated circuit (ASIC) wherein circuit elements are structured and operated to perform the various acts described herein.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A base station node of a radio access network which communicates over a radio interface with a wireless terminal served by the base station node, the wireless terminal operating with discontinuous reception (DRX), the base station node comprising a logic processing circuit configured to determine if the base station node is or may become unsynchronized with a current discontinuous reception (DRX) state of the wireless terminal and to resynchronize operation or take preventative action to maintain synchronized operation of the base station node with the current discontinuous reception (DRX) state of the wireless terminal.

2. The base station node of claim (node generic), wherein the logic processing circuit is configured to determine if the base station node is unsynchronized with the current discontinuous reception (DRX) state of the wireless terminal and to resynchronize operation of the base station node with the current discontinuous reception (DRX) state of the wireless terminal.

3. The base station node of claim 2, wherein the logic processing circuit is configured to determine if the base station node is unsynchronized with the current discontinuous reception (DRX) state of the wireless terminal by determining lack of HARQ feedback on a Physical Uplink Control Channel (PUCCH) from the wireless terminal after the base station node has scheduled a downlink transmission to the wireless terminal.

4. The base station node of claim 3, wherein if it is determined that the base station node is unsynchronized with the current discontinuous reception (DRX) state of the wireless terminal, the logic processing circuit is further configured to:
stop any ongoing retransmission of information from the base station node to the wireless terminal;
postpone any new transmission of information from the base station node to the wireless terminal;
stop or postpone any radio link control (RLC) layer retransmissions from the base station to the wireless terminal;
stop scheduling uplink transmissions from the wireless terminal to the base station node.

5. The base station node of claim 2, wherein the logic processing circuit is configured to determine if the base station node is unsynchronized with the current discontinuous reception (DRX) state of the wireless terminal by determining lack of a reception on a Physical Uplink Shared Channel (PUSCH) from the wireless terminal after the base station node has scheduled an uplink transmission from the wireless terminal.

6. The base station node of claim 5, wherein if it is determined that the base station node is unsynchronized with the current discontinuous reception (DRX) state of the wireless terminal, the logic processing circuit is configured to:
stop scheduling uplink transmissions from the wireless terminal to the base station node; and
postpone any new transmission of information from the base station node to the wireless terminal.

7. The base station node of claim 2, wherein the logic processing circuit is configured to determine if the base station node is unsynchronized with the current discontinuous reception (DRX) state of the wireless terminal by both:
determining lack of HARQ feedback on a Physical Uplink Control Channel (PUCCH) from the wireless terminal after the base station node has scheduled a downlink transmission to the wireless terminal; and
determining lack of a transmission on a Physical Uplink Shared Channel (PUSCH) from the wireless terminal after the base station node has scheduled an uplink transmission from the wireless terminal.

8. The base station node of claim 2, wherein the logic processing circuit is configured to receive channel quality measurements from the wireless terminal and to use the channel quality measurements to confirm unsynchronization of the base station node with the current discontinuous reception (DRX) state of the wireless terminal.

9. The base station node of claim 1, wherein the logic processing circuit is configured to:
determine if the base station may become unsynchronized with the current discontinuous reception (DRX) state of the wireless terminal; and, if so, take preventative action to maintain synchronized operation of the base station node with the current discontinuous reception (DRX) state of the wireless terminal.

10. The base station node of claim 9, wherein the logic processing circuit is configured to determine if the base station node may become unsynchronized with the current discontinuous reception (DRX) state of the wireless terminal by monitoring a coverage level on a downlink (DL) from the base station node to the wireless terminal.

11. The base station node of claim 9, wherein the logic processing circuit is configured to take preventive action by performing at least one of the following:
increasing robustness of a HARQ transmission which contains an initial DL assignment;
changing configuration of the discontinuous reception (DRX); and
aligning RLC by transmitting and retransmitting PDUs with intervals and counters matched to reception phases of the DRX scheme.

12. The base station node of claim 9, wherein the logic processing circuit is configured to determine if, despite the preventative action, the base station node becomes unsynchronized with the current discontinuous reception (DRX) state of the wireless terminal; and, if so, to resynchronize operation of the base station node with the current discontinuous reception (DRX) state of the wireless terminal.

13. A base station node of a radio access network which communicates over a radio interface with a wireless terminal served by the base station node, the wireless terminal operating with discontinuous reception (DRX), the base station node comprising a logic processing circuit configured to take preventative action to maintain synchronized operation of the base station node with the current discontinuous reception (DRX) state of the wireless terminal

14. The base station node of claim 13, wherein the preventive action comprises at least one of the following:
increasing robustness of a HARQ transmission which contains an initial DL assignment;
changing configuration of the discontinuous reception (DRX); and
aligning RLC by transmitting and retransmitting PDUs with intervals and counters matched to reception phases of the DRX scheme.

15. A method of operating a base station node of a radio access network, the method comprising:
communicating information over a radio interface between the base station node and a wireless terminal which operates with discontinuous reception (DRX);
determining if the base station node is or may become unsynchronized with a current discontinuous reception (DRX) state of the wireless terminal; and, if so, resynchronizing operation or taking preventative action to maintain synchronized operation of the base station node with the current discontinuous reception (DRX) state of the wireless terminal.

16. The method of claim 15, further comprising:
determining if the base station node is unsynchronized with the current discontinuous reception (DRX) state of the wireless terminal; and, if so,
resynchronizing operation of the base station node with the current discontinuous reception (DRX) state of the wireless terminal.

17. The method of claim 16, further comprising determining that the base station node is unsynchronized with the current discontinuous reception (DRX) state of the wireless terminal by determining lack of HARQ feedback on a Physical Uplink Control Channel (PUCCH) from the wireless terminal after the base station node has scheduled a downlink transmission to the wireless terminal.

18. The method of claim 17, wherein if it is determined that the base station node is unsynchronized with the current discontinuous reception (DRX) state of the wireless terminal, the method further comprises:
stopping any ongoing retransmission of information from the base station node to the wireless terminal;
postponing any new transmission of information from the base station node to the wireless terminal;
stopping or postponing any radio link control (RLC) layer retransmissions from the base station to the wireless terminal;
stopping scheduling uplink transmissions from the wireless terminal to the base station node.

19. The method of claim 16, further comprising determining that the base station node is unsynchronized with the current discontinuous reception (DRX) state of the wireless terminal by determining lack of a reception on a Physical Uplink Shared Channel (PUSCH) from the wireless terminal after the base station node has scheduled an uplink transmission from the wireless terminal.

20. The method of claim 19, wherein if it is determined that the base station node is unsynchronized with the current discontinuous reception (DRX) state of the wireless terminal, the method further comprises:
stopping scheduling uplink transmissions from the wireless terminal to the base station node;
postponing any new transmission of information from the base station node to the wireless terminal.

21. The method of claim 16, further comprising determining that the base station node is unsynchronized with the current discontinuous reception (DRX) state of the wireless terminal by both:
determining lack of HARQ feedback on a Physical Uplink Control Channel (PUCCH) from the wireless terminal after the base station node has scheduled a downlink transmission to the wireless terminal; and
determining lack of a transmission on a Physical Uplink Shared Channel (PUSCH) from the wireless terminal after the base station node has scheduled an uplink transmission from the wireless terminal.

22. The method of claim 16, further comprising receiving channel quality measurements from the wireless terminal and using the channel quality measurements to confirm unsynchronization of the base station node with the current discontinuous reception (DRX) state of the wireless terminal.

23. The method of claim 15, further comprising:
determining if the base station may become unsynchronized with the current discontinuous reception (DRX) state of the wireless terminal; and, if so, taking preventative action to maintain synchronized operation of the base station node with the current discontinuous reception (DRX) state of the wireless terminal.

24. The method of claim 23, wherein determining if the base station node may become unsynchronized with the current discontinuous reception (DRX) state of the wireless terminal comprises monitoring a coverage level on a downlink (DL) from the base station node to the wireless terminal.

25. The method of claim 23, wherein the preventive action comprises at least one of the following:
increasing robustness of a HARQ transmission which contains an initial DL assignment;
changing configuration of the discontinuous reception (DRX); and
aligning RLC by transmitting and retransmitting PDUs with intervals and counters matched to reception phases of the DRX scheme.

26. The method of claim 23, further comprising:
determining if, despite the preventative action, the base station node becomes unsynchronized with the current discontinuous reception (DRX) state of the wireless terminal; and, if so,
resynchronizing operation of the base station node with the current discontinuous reception (DRX) state of the wireless terminal.

27. A method of operating a base station node of a radio access network, the method comprising:
communicating information over a radio interface between the base station node and a wireless terminal which operates with discontinuous reception (DRX);
taking preventative action to maintain synchronized operation of the base station node with the current discontinuous reception (DRX) state of the wireless terminal.

28. The method of claim 23, wherein the preventive action comprises at least one of the following:
increasing robustness of a HARQ transmission which contains an initial DL assignment;
changing configuration of the discontinuous reception (DRX); and
aligning RLC by transmitting and retransmitting PDUs with intervals and counters matched to reception phases of the DRX scheme.

29. A method of operating a wireless terminal which communicates with a base station node of a radio access network, the method comprising:
reporting to the base station node indications of downlink coverage based on trigger events configured for facilitating DRX management; and
receiving instructions for combating DRX deadlock and implementing those instructions.
